(19) United States
(12) Patent Application Publication
(10) Pub. No.: US 2021/0310508 A1
(43) Pub. Date: Oct. 7, 2021

(54) ADHESIVE MOUNTING DEVICES

(71) Applicant: 3M INNOVATIVE PROPERTIES COMPANY, St. Paul, MN (US)

(72) Inventors: Michael B. Runge, Stillwater, MN (US); Margaret M. Sheridan, Woodbury, MN (US); Craig D. Thompson, Inver Grove Heights, MN (US); Joseph A. Hoffman, Minneapolis, MN (US); Brett P. Krull, Minneapolis, MN (US)

(21) Appl. No.: 16/328,394

(22) PCT Filed: Aug. 25, 2017
(86) PCT No.: PCT/US2017/048654

§ 371 Date: Feb. 26, 2019

Related U.S. Application Data
(60) Provisional application No. 62/526,200, filed on Jun. 28, 2017.
(60) Provisional application No. 62/379,812, filed on Aug. 26, 2016.

(51) Int. Cl. F16B 11/00; F16B 45/00; F16B 47/00

(52) U.S. Cl. CPC F16B 11/006; A47G 1/17; F16B 47/003; F16B 45/00

(57) ABSTRACT

The present disclosure generally relates to adhesive mounting assemblies that are capable of attaching or adhering to a surface and that can be removed from the surface without causing damage to the surface. In some embodiments, the mounting assemblies are peeled off the surface. The present disclosure generally relates to adhesive articles including a mounting device. The adhesive articles have one or more adhesive areas (which can be part of one continuous adhesive area) exhibiting adhesive properties and one or more non-adhesive areas that lack significant adhesive properties. At least one of the non-adhesive areas is located in an area and/or has a size, shape, and/or geometry that lowers and/or controls at least one of the average peel force and/or the peak peel force of the adhesive article such that the peel force of the adhesive article does not exceed the threshold for causing damage to the surface from which the adhesive article is peeled. In some embodiments, at least one non-adhesive area is adjacent to or aligned with the mounting device on either the same major surface of a backing or on the opposing surface of the backing.

### TECHNICAL FIELD

The present disclosure generally relates to adhesive mounting devices that are capable of attaching or adhering to a surface and that can be peeled off the surface without causing damage to the surface. The present disclosure also generally relates to methods of making and using such adhesive mounting devices.

### BACKGROUND

The revolutionary Command® Adhesive Strip products are a line of stretch releasable adhesive strips that holds strongly on a variety of surfaces (including paint, wood, and tile) and that remove cleanly—no holes, marks, or sticky residue. In general, these products include a stretch release pressure sensitive adhesive composition disposed on tape or other backings. These products generally have utility in bonding to various surfaces or substrates for numerous applications. Stretch-release products are designed to firmly adhere an article, such as a hook (to hold a picture or an article of clothing) or other decorative or utilitarian element, to a surface (an adherend), yet remove cleanly when pulled away from the surface at a low angle. The clean removal aspect is so that a tacky and/or unsightly residue is not left behind on the surface after removal of the stretch release adhesive. During the process of stretch release removal, the adhesive layer preferably remains adhered to the tape backing as the backing is stretched, but releases from the surface (adherend).

Peelable adhesive technology was recently introduced into products for mounting. Some exemplary commercially available peelable mounting products (e.g., Jimmy Hook™ products, GeckoTech™ products, Elmer's Freestyle™ products, and Hook Um™ products) rely on both suction technology and frictional or dry adhesives to generate the mounting device's holding power. The mounting devices include a semi-rigid plastic backing and a rigid hook, both of which are integrated as a one-piece article support. The rigid hook is permanently attached to a first major planar surface of the semi-rigid plastic backing. The second major planar surface of the backing can be adhered to a wall surface. The second major planar surface includes one or more of suction technology (e.g., numerous microsuction or nanosuction elements) and/or a frictional adhesive (in which the backing is impregnated with a rubber-based adhesive to increase friction between the substrate and backing) or dry adhesive (which relies on van der Waals forces). The entire construction can, thereafter, be removed by peeling.

### SUMMARY

The inventors of the present disclosure recognized that the existing peelable mounting products suffered from various disadvantages. Because of their low adhesiveness, the existing peelable mounting products did not consistently work. Further, they did not work well on painted surfaces or rough surfaces (e.g., drywall). Additionally, the existing peelable mounting products have low shear strength and thus can hold little weight.

The inventors of the present disclosure sought to formulate peelable mounting products and/or adhesive articles with at least one of higher shear strength, that work well on painted or rough surfaces, and/or that are capable of consistently holding higher weights, all without damaging the surface to which they are applied.

The inventors of the present disclosure also recognized that peelable adhesive articles can be attached or adhered to a mounting device (e.g., a hook or clip). In such implementations, the mounting device is typically bonded to the top side of a backing and the bottom side of the backing typically includes an adhesive capable of adhering the backing to a surface. To cleanly peel the mounting article/mounting assembly from the surface requires that peel separation be maintained across the entire assembly. The inventors recognized that one way to maintain the peel separation is to form a mounting article/mounting assembly that lacks active adhesive in at least a portion of the area under or adjacent to at least a portion of the mounting device. In some embodiments, the mounting article/mounting assembly can either lack adhesive in this area or the adhesive in this area can be deadened. In some embodiments, the mounting assembly has a lower stiffness or modulus portion adjacent to an active adhesive and a higher stiffness or modulus portion adjacent to an area that lacks an active adhesive.

The present disclosure generally relates to various embodiments of a peelable adhesive article and/or assembly including a mounting device. The entire construction can be peeled off a surface without damaging the surface. The peelable adhesive articles or assemblies described herein generally have adhesive areas including a pressure sensitive adhesive and non-adhesive areas that lack significant adhesive properties. The non-adhesive areas are located in an area and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled. In some embodiments, the non-adhesive areas are adjacent to or aligned with at least a portion of the mounting device. In some embodiments, the non-adhesive areas are adjacent to or aligned with at least a portion of an area of high stiffness on the peelable adhesive article or assembly.

Some embodiments of the present disclosure relate to an adhesive mounting assembly, comprising: a backing including opposing first and second major planar surfaces separated by a thickness; a first adhesive region on the first major planar surface of the backing, the first adhesive region exhibiting adhesive properties; a second adhesive region on the first major planar surface of the backing, the second adhesive region exhibiting adhesive properties; a non-adhesive region on the first major planar surface of the backing, the non-adhesive region lacking significant adhesive properties and positioned between or adjacent the first and second adhesive regions; and a mounting device adjacent to the backing; wherein the non-adhesive region is adjacent to or aligns with the mounting device.

Some embodiments relate to an adhesive mounting assembly, comprising: a backing including opposing first and second major planar surfaces separated by a thickness; first and second adhesive regions on the first major planar surface of the backing; the first and second adhesive regions each exhibiting adhesive properties; and a mounting device adjacent to the second major planar surface of the backing; the mounting device having a mounting device area; wherein an area of the first major surface that is substantially aligned with or adjacent to at least a portion of the mounting device area is a non-adhesive region that lacks significant adhesive properties and wherein the non-adhesive region is between and/or adjacent to the first and second adhesive regions.

Some embodiments relate to an adhesive mounting assembly, comprising: a region of lower stiffness or modulus; a region of higher stiffness or modulus; wherein the region of lower stiffness or modulus is adjacent to an adhesive region that exhibits adhesive properties; and wherein the region of higher stiffness or modulus is adjacent to a non-adhesive region that does not exhibit significant adhesive properties. In some embodiments, the region of higher stiffness or modulus includes a mounting device that is at least one of a hook, clip, magnet, detachable mechanical fastener, snap, and loop. In some embodiments, the region of lower stiffness has a Young's modulus of between about 600 PSI and about 1500 PSI as measured by ASTM D638. In some embodiments, the region of higher stiffness has a Young's modulus of between about 660 PSI and about 2000 PSI as measured by ASTM D638.

Some embodiments relate to a method of forming an adhesive mounting device, comprising: (1) providing a backing including (a) opposing first and second planar surfaces separated by a thickness; and (b) first and second terminal ends; (2) forming a first adhesive region and a second adhesive region on the first major planar surface of the backing, the first and second adhesive regions including a peelable adhesive; and (3) providing a mounting device adjacent to the first major planar surface of the backing. The non-adhesive region on the first major planar surface is adjacent to or aligns with the mounting device and is between or adjacent to each of the first and second adhesive regions. In some embodiments, forming the first and second adhesive regions comprises applying a peelable adhesive on the first major planar surface of the backing.

Some embodiments relate to a method of forming an adhesive mounting device, comprising: (1) providing a backing including (a) opposing first and second planar surfaces separated by a thickness; and (b) first and second terminal ends; (2) forming a first adhesive region and a second adhesive region on the first major planar surface of the backing; the first and second adhesive regions including a peelable adhesive; and (3) providing a mounting device adjacent to the second major planar surface of the backing. An area of the first major surface is substantially aligned with or adjacent to at least a portion of the mounting device area is a non-adhesive region and wherein the non-adhesive region is between or adjacent to each of the first and second adhesive regions. In some embodiments, forming the first and second adhesive regions comprises applying a peelable adhesive on the first major planar surface of the backing.

Some embodiments relate to a method of using an adhesive mounting device, comprising: adhering any of the adhesive mounting assemblies described herein to a surface; and removing the adhesive article from the surface. In some embodiments, removing a release liner from the adhesive mounting assembly before adhering it to the surface. In some embodiments, the method involved gripping a tab portion of the adhesive mounting assembly and lifting it to begin or progress the process of removing the adhesive mounting assembly from the surface. In some embodiments, removal of the adhesive article from the surface involves peeling the adhesive article from the surface.

In some embodiments, the mounting device is at least one of a hook, clip, magnet, detachable mechanical fastener, snap, loop, or detachable mechanical fastener. In some embodiments, the adhesive region includes an adhesive that includes at least one of natural rubber, synthetic rubber such as SBS, SIS, SEBS, acrylate, polyurethane, silicone, silicone block copolymers, and combinations thereof. In some embodiments, the adhesive region includes an adhesive that includes a tackifier selected from a list consisting essentially of terpene phenol, polyterpene, rosin esters, rosin acids, C5 tackifiers, and/or C9 tackifiers.

In some embodiments, the backing includes at least one of plastic, metal, paper, nonwoven material, woven material, foam, and/or a filament reinforced material.

In some embodiments, the backing is at least one of a single layer film or a multilayer film. In some embodiments, the backing exhibits an elastic recovery of 1-99% at 10% strain. In some embodiments, the backing exhibits an elastic recovery of 1-99% at 20% strain. In some embodiments, the backing has a thickness of between about 0.1 mil and about 100 mils.

In some embodiments, the non-adhesive region includes a deadening layer that substantially diminishes the adhesive properties of the adhesive and wherein the deadening layer is located adjacent to the adhesive. In some embodiments, the deadening layer has a thickness of between about 0.1 mil and about 10 mils. In some embodiments, the deadening layer comprises at least one of a coating, a film, ink, lacquer, and/or a chemical reaction initiated by radiation.

In some embodiments, the high stiffness region has a stiffness that is at least about 5% greater than the stiffness in a low stiffness region of the adhesive mounting assembly.

In some embodiments, the non-adhesive region has a size, and the non-adhesive region size is within 10% of a size of the mounting device. In some embodiments, the non-adhesive region adjacent to or aligning with the mounting device has a size, and wherein the size of the non-adhesive region is within 5% of a size of the mounting device and/or the mounting device area. In some embodiments, the non-adhesive region is larger than a size of the mounting device and/or a mounting device area. In some embodiments, the non-adhesive region is more than 10% larger than the size of the mounting device and/or the mounting device area. In some embodiments, the non-adhesive region is smaller than a size of the mounting device and/or a mounting device area. In some embodiments, the non-adhesive region has a size that is less than 95% of a size of the mounting device and/or the mounting device area. In some embodiments, the non-adhesive region has a size of between about 60 mm² and about 100,000 mm². In some embodiments, the non-adhesive region has a shape selected from at least one of rectangular, pentagonal, hexagonal, triangular, quadrilateral, curved, star-shaped, conical, trapezoidal, polygonal, teardrop, and arrow-shaped.

In some embodiments, the adhesive is peelable. In some embodiments, the non-adhesive region comprises between about 10% and about 90% percent of a total adhesive article area. In some embodiments, the non-adhesive region comprises between about 15% and about 45% percent of a total adhesive article area. In some embodiments, the adhesive region comprises between about 10% and about 90% area percent of a total adhesive article area. In some embodiments, the adhesive region comprises between about 20% and about 80% percent of a total adhesive article area. In some embodiments, the adhesive region has a width extending between first and second opposed side ends of the backing, and the width of the adhesive region decreases as the adhesive region approaches a tab and/or a first terminal end of the backing.

In some embodiments, the mounting device is capable of holding at least 0.3 pounds. In some embodiments, the assembly has a sheer capacity of at least 1 lb per square inch.

In some embodiments, the non-adhesive region at least one of (1) lacks a pressure sensitive adhesive; (2) includes a deadening layer that minimizes or eliminates the adhesion of the pressure sensitive adhesive in the non-adhesive region; and/or (3) has undergone an adhesive degradation process. In some embodiments, the adhesive degradation process is one of radiation exposure, UV, ebeam, or other chemical transformations.

As used herein, “layer” means a single stratum that may be continuous or discontinuous over a surface.

As used herein, the terms “top” and “bottom” are for illustrative purposes only, and do not necessarily define the orientation or the relationship between the various layers of the adhesive articles describe herein. Accordingly, the terms “top” and “bottom” should be considered interchangeable.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a,” “an,” “the,” “at least one,” and “one or more” are used interchangeably. Thus, for example, a core comprising “a” pattern of recesses can be interpreted as a core comprising “one or more” patterns.

Also herein, the recitations of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF DRAWINGS

FIG. 1 is a top view of an exemplary prior art adhesive strip.

FIGS. 2A-2C are respective perspective, front, and side views of an adhesive mounting assembly in accordance with the teachings herein.

FIGS. 3A-3D are respective perspective, front, side, and rear views of an adhesive mounting assembly in accordance with the teachings herein.

FIG. 4A is an exploded view of an exemplary embodiment of a disassembled adhesive mounting assembly in accordance with the teachings herein.

FIG. 4B is a front view of the adhesive mounting assembly of FIG. 4A assembled.

FIG. 5A is an exploded view of an exemplary embodiment of a disassembled adhesive mounting assembly in accordance with the teachings herein.

FIG. 5B is a front view of the adhesive mounting assembly of FIG. 6A assembled.

FIGS. 6A-6B are respective front and side views of an exemplary assembled adhesive mounting assembly in accordance with the teachings herein.

FIG. 6C is a perspective view of the adhesive mounting assembly of FIGS. 6A and 6B unassembled.

FIG. 7A is an exploded perspective view of an exemplary embodiment of a disassembled adhesive mounting assembly in accordance with the teachings herein.

FIG. 7B is an exploded perspective view of the adhesive mounting assembly of FIG. 7A partially assembled.

FIG. 7C is a perspective view of the adhesive mounting assembly of FIGS. 7A and 7B assembled.

FIGS. 8A-8C are respective front, sectional and expanded sectional views of an exemplary adhesive mounting assembly in accordance with the teachings herein.

FIGS. 9-12 are schematic drawings of exemplary adhesive mounting assemblies in accordance with the teachings herein.

FIGS. 13A-13C are respective perspective, front, and rear schematic views of an exemplary mounting assembly in accordance with the teachings herein.

FIGS. 14A-14C are respective perspective, front, and rear schematic views of an exemplary mounting assembly in accordance with the teachings herein.

FIG. 15 is a perspective view of an adhesive mounting assembly in accordance with the present disclosure;

FIG. 16 is a cross-sectional view of the adhesive mounting assembly of FIG. 2.

FIG. 17A is a front perspective view of an adhesive mounting assembly in accordance with the present disclosure;

FIG. 17B is a front perspective view of a backing within the adhesive mounting assembly of FIG. 17A;

FIG. 17C is a rear perspective view of the mounting assembly of FIG. 17A;

FIG. 18 is a rear perspective view of an adhesive mounting assembly in accordance with the present disclosure; and

FIG. 19 is an exploded perspective view of a disassembled adhesive mounting assembly of FIG. 18.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The present disclosure generally relates to adhesive articles that can be peeled off a substrate without damage. As used herein, the term “peelable” means that the adhesive article can be removed from a substrate or surface by peeling at angle of between about 1° and about 180°. In some embodiments, the adhesive article can be removed from a substrate or surface by peeling at angle of between 30° to 120°. In some embodiments, the adhesive article can be removed from a substrate or surface by peeling at angle of at least about 35°. Peelable adhesive articles were described in, for example, PCT Patent Publication No. 2015/034104, the entire disclosure of which is incorporated herein. As used herein, the term “damage-free” or the like means free of significant alteration in the physical appearance of the substrate to which the adhesive article is applied, for example the undesirable tearing of the paper layer of drywall. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

The adhesive articles have adhesive areas including a pressure sensitive adhesive and non-adhesive areas that lack significant adhesive properties. As used herein, the term “non-adhesive regions” refers to one or more regions of the adhesive article having a reduction in adhesive properties (peel adhesion or tack) as compared to the adhesive region(s) ranging from about 1% to about 100% as measured by ASTM D3330/3330M-04 (for peel adhesion) and/or ASTM D2979-01 (2009) (probe tack). In presently preferred implementations, the non-adhesive region article has a reduction in adhesive properties (peel adhesion or tack) as compared to the adhesive region(s) ranging from about 95% to about 100%; in other implementations, particularly those suitable for use with at least one of delicate and textured surfaces, the non-adhesive region(s) have a reduction in adhesive properties (peel adhesion or tack) as compared to an adhesive region(s) of at least about 99%.

The non-adhesive areas have a location and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled. In some embodiments, the average peel force and/or the peak peel force is 30 oz or less. In some embodiments, the average peel force and/or the peak peel force is 35 oz or less. In some embodiments, the average peel force and/or the peak peel force is 40 oz or less. In some embodiments, the average peel force and/or the peak peel force is 45 oz or less. In some embodiments, the average peel force and/or the peak peel force is 50 oz or less.

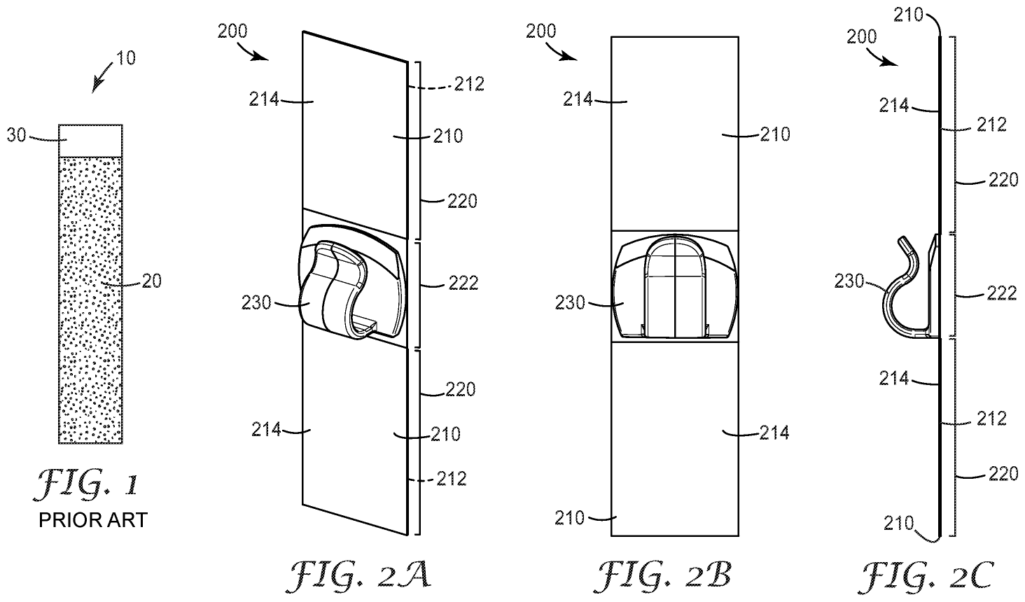

FIG. 1 is a top view of an exemplary adhesive article. Adhesive article 10 includes an adhesive region 20 and a non-adhesive region 30. Non-adhesive region 30 is limited to or forms a tab. The inventors of the present disclosure recognized that peel removal of a peelable adhesive article has two distinct phases: (1) the peel front initiation which corresponds to a kinetic peel force and/or a peak peel force; and (2) the propagation along the adhesive backing of the peel front, which corresponds to the average peel force. The average peel force is typically lower, and sometimes significantly lower, than the peak peel force. When the adhesive article is peeled off or from a surface that is damageable, the area where peel front initiation occurs is where damage is frequently observed. This is because the peel force is highest at the point of initiation. Often this peak peel force at the point of initiation exceeds or is greater than the threshold for causing damage. When the peel force exceeds the threshold for causing damage, undesirable substrate or surface damage occurs.

The inventors of the present application further discovered that by tailoring the shape or geometry of the non-adhesive and/or adhesive region(s) on the adhesive article, the peel forces can be affected. More specifically, the peel forces can be tailored or altered so that they do not exceed the damage threshold of the substrates on which the adhesive article will be used or adhered.

The inventors of the present disclosure then found that including a non-adhesive region on the opposite side of the backing as the mounting device in an area that is adjacent to or overlaps with the mounting device area provides an adhesive article with a peak peel force that does not exceed the damage threshold on substrates including, for example, drywall, paint, glass, etc. The inventors of the present disclosure also discovered that including a non-adhesive region on the directly opposite side of the backing from an adhesive region area provides an adhesive article with a peak peel force that does not exceed the damage threshold on substrates including, for example, drywall, paint, glass, etc. As such, the inventors of the present disclosure found adhesive mounting articles that can be adhered to and peeled from various substrates without causing damage. These adhesive mounting articles can hang or mount article of various weights.

One exemplary embodiment of an adhesive mounting device of the type described herein is shown in FIGS. 2A-2C. Adhesive mounting device 200 includes a backing 210 including first and second opposed major surfaces 212 and 214. Two adhesive areas, regions, or portions 220 of first (or rear) major planar surface 212 of backing 210 are coated with an adhesive. A non-adhesive area, region, or portion 222 of first (or rear) major planar surface 212 of backing 210 lacks adhesive functionality and/or is not significantly adhesive. Non-adhesive region 222 is between the two adhesive regions 220. A mounting device 230 (shown in this specific embodiment as a hook) is on second major planar surface 214 of backing 210 in the area of non-adhesive region 222.

Many changes may be made to the specific embodiment shown in FIGS. 2A-2C. For example, the mounting device can be any desired mounting device. Multiple mounting devices can be present. The shape and size of the mounting device and/or backing can be any desired shape or size.

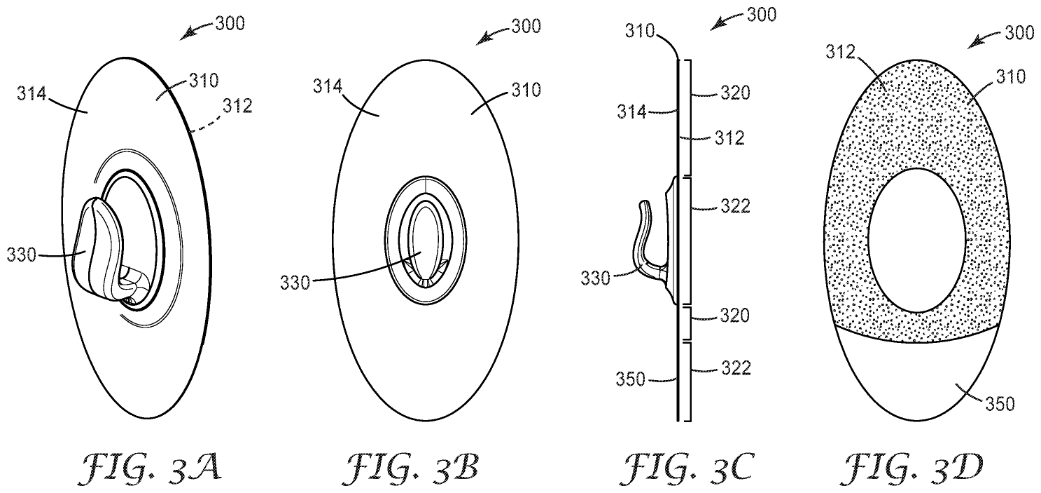

Another exemplary embodiment of an adhesive mounting assembly of the type described herein is shown in FIGS. 3A-3C. Adhesive mounting assembly 300 includes a backing 310 including first and second opposed major surfaces 312 and 314 and a mounting device 330. An adhesive area, region, or portion 320 of first (or rear) major planar surface 312 of backing 310 is coated with an adhesive. One or more non-adhesive areas, regions, or portions 322 of first (or rear) major planar surface 312 of backing 310 lack adhesive functionality or properties and/or are not significantly adhesive. One non-adhesive region 322 is generally adjacent to the area of mounting device 330. Another optional non-adhesive region 322 is located on the bottom end of the adhesive mounting assembly 300, forming a tab 350. Tab 350, where present, is an area that can be easily accessed by the user to assist in or begin to remove the adhesive mounting assembly from the adherend. Mounting device 330 (shown in this specific embodiment as a hook) is on second major planar surface 314 of backing 310 in the area of non-adhesive region 322. As is described herein, many changes may be made to the specific embodiment shown in FIGS. 3A-3C.

The presence of mounting device 330 makes the portion of backing 310 including mounting device 330 a higher stiffness region as compared to the portion of backing 310 lacking mounting device 330 (the lower stiffness region).

Adhesive mounting assembly 300 can be formed as a single component construction whereby, for example, the adhesive mounting assembly is cast or molded using a single material or multiple materials. Alternatively, adhesive mounting assembly 300 can be formed as a two component construction whereby a separately formed mounting device 330 is adhered or attached to a separately formed backing 310 during, for example, manufacturing or consumer use. Exemplary methods of attaching the backing and mounting device include, but are not limited to, solvent bonding, adhesive bonding, UV curable adhesive bonding, ultrasonic welding, EVA bonding films, etc.

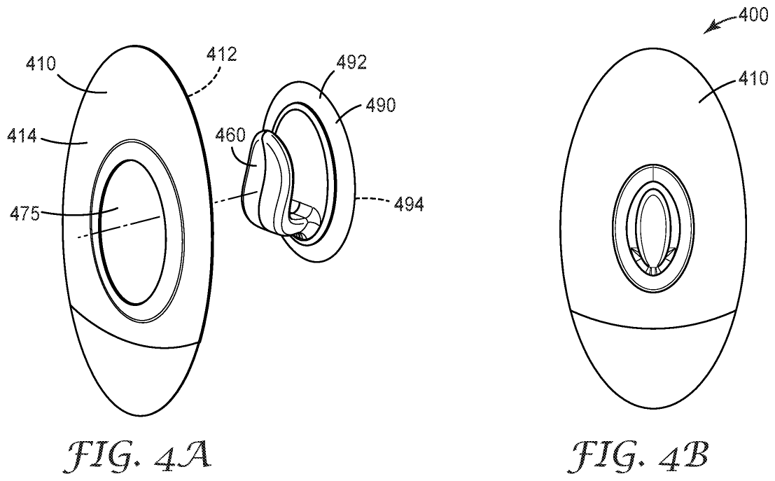

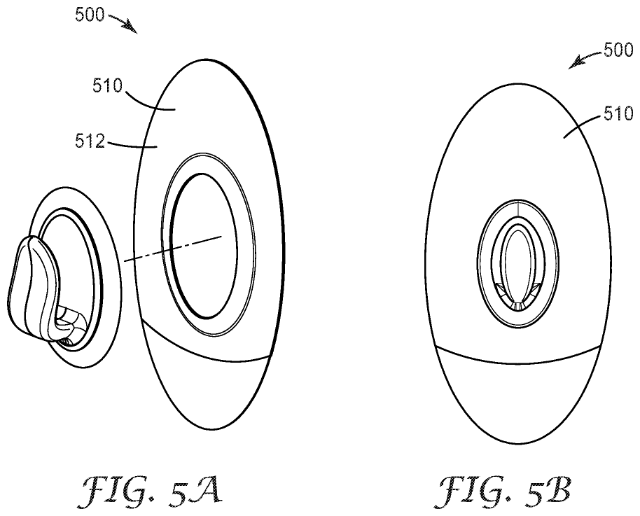

Mounting assemblies of type generally shown in FIGS. 3A-3D can be made in multiple ways. For example, the mounting device can be attached to either the first major surface of the backing or the second major surface of the backing. More specifically, in some embodiments, a portion of the mounting device is adhered to the second major (front) surface 314 of backing 310. In some embodiments, a portion of the mounting device is adhered to the first major (rear) surface 314 of backing 310. Some exemplary implementations of these are shown and described in FIGS. 4A-4B and 5A-5B.

Adhesive mounting assembly 400 of FIGS. 4A and 4B include a backing 410 including first and second opposed major surfaces 412 and 414 and a mounting device 430 (shown in this specific embodiment as a hook). FIG. 4A shows an unassembled mounting assembly; FIG. 4B shows an assembled mounting assembly. Mounting device 430 includes a hook portion 480 and a flange portion 490. A first (front) surface 492 of flange portion 490 is opposite a second (rear) surface 494 of flange portion 490. In the embodiment of FIGS. 4A and 4B, hook portion 480 passes through a hole 475 in disassembled adhesive mounting assembly 400 until first (front) surface 492 of flange portion 490 contacts first (rear) surface 412 of backing 410. Backing 410 and mounting device 430 can be held securely together in multiple ways including, for example, adhesive bonding, solvent bonding, UV curable adhesive bonding, ultrasonic welding, EVA bonding films, etc.

At least a portion of second (rear) surface 494 of flange portion 490 and/or the back of the hook portion 480 lacks adhesive or significant adhesive properties. As such, the assembled adhesive mounting assembly (shown in FIG. 4B) includes an adhesive area, region, or portion 420 of first (or rear) major planar surface 412 of backing 410 that is coated with an adhesive and one or more non-adhesive areas, regions, or portions 422 of first (or rear) major planar surface 412 of backing 410 that lack adhesive functionality or properties and/or are not significantly adhesive. Adhesive regions 420 and non-adhesive regions 422 are substantially the same as those shown in FIG. 3D. One non-adhesive region 422 is between the two adhesive regions 420 and overlaps with at least a portion of a mounting device. The second non-adhesive region 422 is optional and is located on the bottom end of the adhesive mounting assembly 400, forming a tab 450. Tab 450, where present, is an area that can be easily accessed by the user to assist in or begin to remove the adhesive assembly from the adherend.

The presence of mounting device 430 makes the portion of backing 410 including mounting device 430 a higher stiffness region as compared to the portion of backing 410 lacking mounting device 430 (the lower stiffness region).

As is described herein, many changes may be made to the specific embodiment shown in FIGS. 4A-4B.

Adhesive mounting assembly 500 of FIGS. 5A and 5B include a backing 510 including first and second opposed major surfaces 512 and 514 and a mounting device 530 (shown in this specific embodiment as a hook). FIG. 5A shows an unassembled mounting assembly; FIG. 5B shows an assembled mounting assembly. Mounting device 530 includes a hook portion 580 and a flange portion 590. A first (front) surface 592 of flange portion 590 is opposite a second (rear) surface 594 of flange portion 590. In the embodiment of FIGS. 5A and 5B, second (rear) surface of flange portion 590 attaches to or mates with a complementary portion of backing 510. Backing 510 and mounting device 530 can be held securely together in multiple ways including, for example, adhesive bonding, solvent bonding, UV curable adhesive bonding, ultrasonic welding, EVA bonding films, etc.

At least a portion of the rear or back surface of hook portion 580 lacks adhesive or lacks significant adhesive properties. As such, the assembled adhesive mounting assembly (shown in FIG. 5B) includes an adhesive area, region, or portion 520 of first (or rear) major planar surface 512 of backing 510 that is coated with an adhesive and one or more non-adhesive areas, regions, or portions 522 of first (or rear) major planar surface 512 of backing 510 that lack adhesive functionality or properties and/or are not significantly adhesive. Adhesive regions 520 and non-adhesive regions 522 are substantially the same as those shown in FIG. 3D. One non-adhesive region 522 is between the two adhesive regions 520 and overlaps with at least a portion of a mounting device. The second non-adhesive region 522 is optional and is located on the bottom end of the adhesive mounting assembly 500, forming a tab 550. Tab 550, where present, is an area that can be easily accessed by the user to assist in or begin to remove the adhesive assembly from the adherend.

The presence of mounting device 530 makes the portion of the adhesive mounting assembly 100 including mounting device 530 a higher stiffness region as compared to the portion of the adhesive mounting assembly 100 lacking mounting device 530 (the lower stiffness region). The stiffness of adhesive mounting assembly 100 (or any assembly described herein) is defined by the combination of thickness and Young's modulus. Exemplary mounting assembly thicknesses include those between about 0.1 mils and about 100 mils. Exemplary Young's Modulus's of mounting assemblies described herein are between about 100 PSA and about 15,000 PSI. As used herein, the term “high stiffness region” refers to a region having a stiffness that is at least about 5% greater than a low stiffness region of the adhesive mounting assembly. In some embodiments, the high stiffness region has a stiffness that is between about 5% and about 10,000% greater than the stiffness in a low stiffness region. In some embodiments the high stiffness region has a stiffness that is at least 50% greater than the stiffness in the low stiffness region. In some embodiments the high stiffness region has a stiffness that is at least 100% greater than the stiffness in the low stiffness region. In some embodiments the high stiffness region has a stiffness that is at least 1000% greater than the stiffness in the low stiffness region. In some embodiments the high stiffness region has a stiffness that is at least 5000% greater than the stiffness in the low stiffness region. In some embodiments, the lower stiffness region(s) has a Young's modulus of between about 600 PSI to about 1500 PSI. In some embodiments, the higher stiffness region has a Young's modulus of between about 660 PSI and about 2000 PSI.

As is described herein, many changes may be made to the specific embodiment shown in FIGS. 5A-5B.

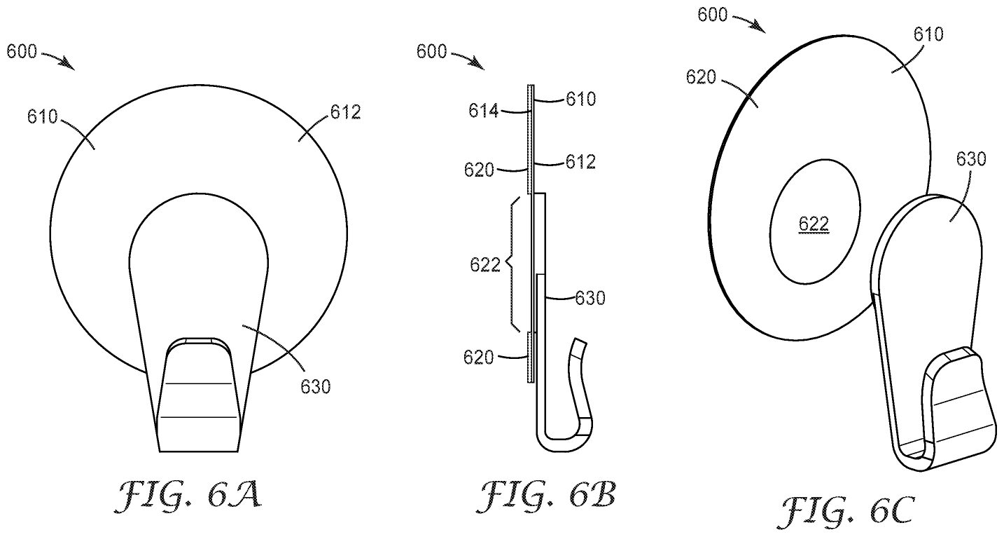

Another exemplary embodiment of an adhesive mounting assembly of the type described herein is shown in FIGS. 6A-6C. Adhesive mounting assembly 600 includes a backing 610 including first and second opposed major surfaces 612 and 614 and a mounting device 630 (shown in this specific embodiment as a hook). An adhesive area, region, or portion 620 of first (or rear) major planar surface 612 of backing 610 is coated with or includes an adhesive. A non-adhesive area, region, or portion 622 of first (or rear) major planar surface 612 of backing 610 lacks adhesive functionality or properties and/or is not significantly adhesive. Mounting device 630 is on second major planar surface 614 of backing 610 in the area of non-adhesive region 622. As is described herein, many changes may be made to the specific embodiment shown in FIGS. 6A-6C.

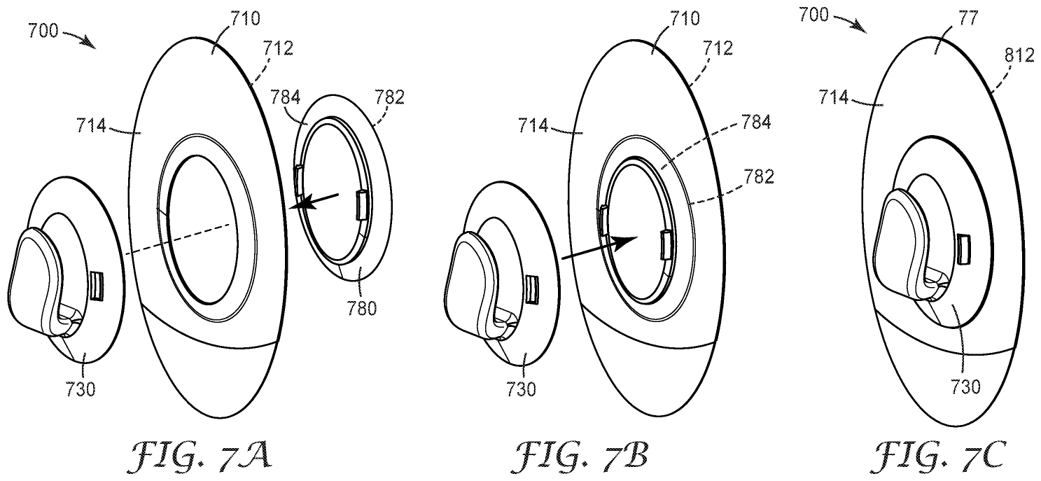

Another exemplary embodiment of an adhesive mounting assembly 700 of the type described herein is shown in FIGS. 7A-7C. FIG. 7A shows mounting assembly 700 unassembled; FIG. 7B shows mounting assembly 700 partially assembled; and FIG. 7C shows mounting assembly 700 fully assembled.

As shown in FIG. 7A, adhesive mounting assembly 700 includes a backing 710, a mounting device 730, and a base 780. Backing 710 includes first and second opposed major surfaces 712 and 714. An adhesive area, region, or portion 720 of first (or rear) major planar surface 712 of backing 710 is coated with an adhesive. One or more non-adhesive areas, regions, or portions 722 of first (or rear) major planar surface 712 of backing 710 lack adhesive functionality or properties and/or are not significantly adhesive. The adhesive and non-adhesive areas or regions are substantially the same as shown in FIG. 3D. One non-adhesive region 722 is generally adjacent to the area of mounting device 730. Another optional non-adhesive region 722 is located on the bottom end of the adhesive mounting assembly 700, forming a tab 750. Tab 750, where present, is an area that can be easily accessed by the user to assist in or begin to remove the adhesive mounting assembly from the adherend.

Base 780 includes a rear major surface 782 and a front major surface 784. During assembly, front major surface 784 of base 780 contacts and attaches to first (rear) major surface of backing 710. The attachment of base 780 to backing 710 can be permanent or temporary/releasable. Permanent attachment may be desired in instances where the attachment is performed during manufacturing while temporary attachment may be desired in instances where the attachment is performed by a consumer altering the hooks used on a peelable or repositionable backing. The attachment can be effected by any known method including, for example, mechanical connection (e.g., snap fit, threads, twist-lock, etc.), chemical bonding, adhesive bonding, welding, ultrasonic bonding, etc. In some embodiments, front major surface 784 of base 780 has a perimeter area that approximates or matches first major (rear) surface 712 of backing 710.

The next step during assembly is attaching or adhering mounting device 730 to the base/backing 780/710 assembly. The rear major surface 732 of mounting device 730 is placed directly adjacent to second major (front) surface of backing 710. Mounting device 730 can be held in place by either a connection to backing 710 or to base 780 or both. This can be effected by any known method including, for example, mechanical connection (e.g., snap fit, threads, twist-lock, etc.), chemical bonding, adhesive bonding, welding, ultrasonic bonding, etc.

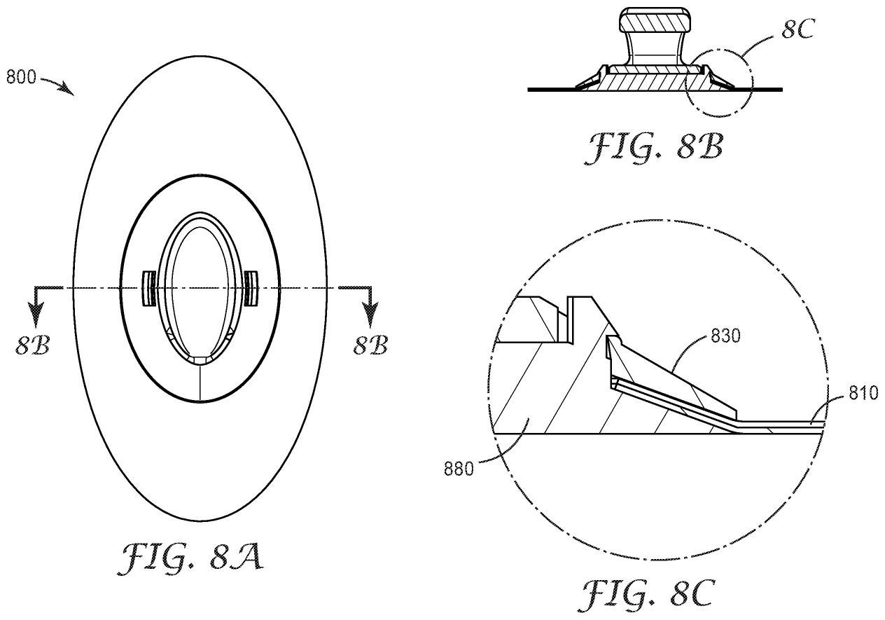

One exemplary embodiment of the adhesive mounting assembly of FIGS. 7A-7C is shown in FIG. 8. Mounting assembly 800 includes a mechanical attachment between base 880 and mounting device 830. Backing 810 is mechanically trapped by barbs 892 on the underside of mounting device 830.

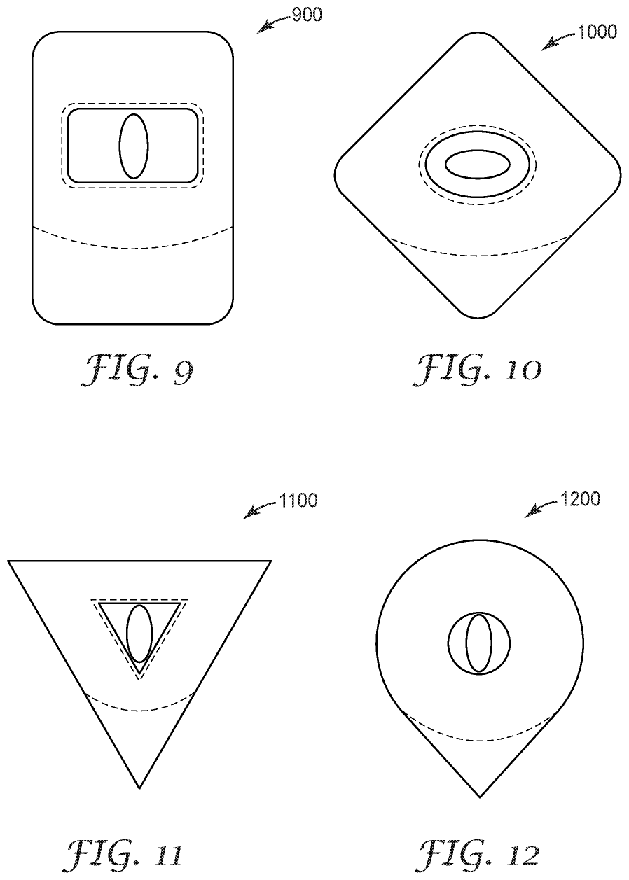

Many changes may be made to the specific embodiments shown in FIGS. 2-8 and described above. For example, each of the embodiments can have different shapes, sizes, or thicknesses. Various exemplary shapes of mounting assemblies are shown in FIGS. 9-12. The exemplary mounting assembly 900 of FIG. 9 is generally rectangular in shape. The exemplary mounting assembly 1000 of FIG. 10 is generally square or diamond in shape with the lower point or corner acting as a tab portion. The exemplary mounting assembly 1100 of FIG. 11 is generally triangular in shape with one of the points or corners acting as a tab portion. The exemplary mounting assembly 1200 of FIG. 12 is generally circular in shape with a generally triangular tab extending from the circular portion. The embodiments and shapes shown in the figures herein are merely exemplary. Any desired shape may be used.

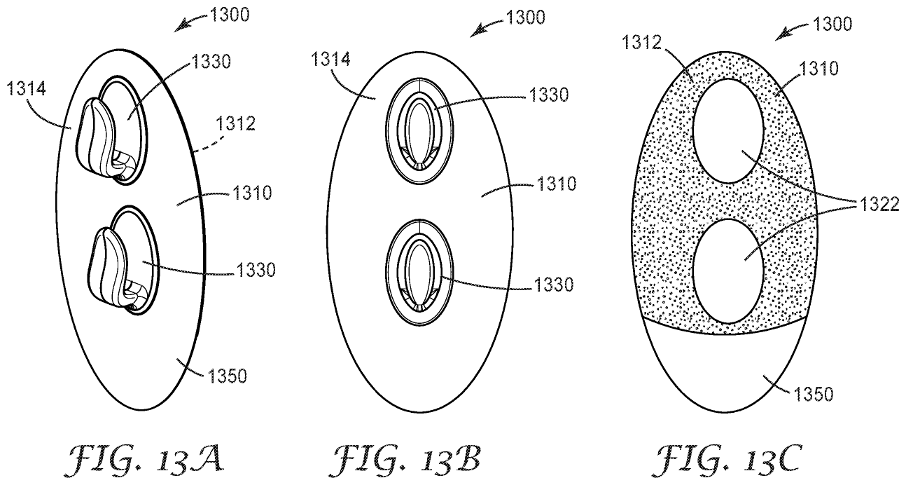

A mounting assembly can include more than one mounting device. Any desired number of mounting devices can be used. FIGS. 13A-13C are, respective, perspective, front, and rear schematic views of an exemplary mounting assembly embodiment 1300 including two mounting devices. Mounting assembly 1300 is substantially similar to the mounting assembly of FIG. 3A-3D except that it includes two mounting devices 1330. A non-adhesive region 1322 is preferably adjacent to or aligned with one or more, and preferably all of, mounting devices 1322.

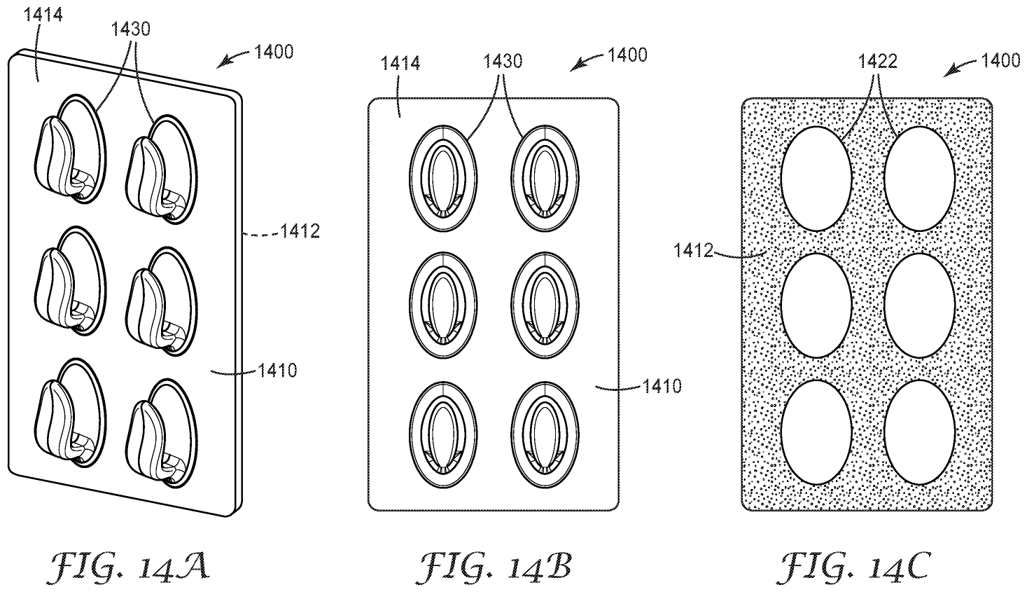

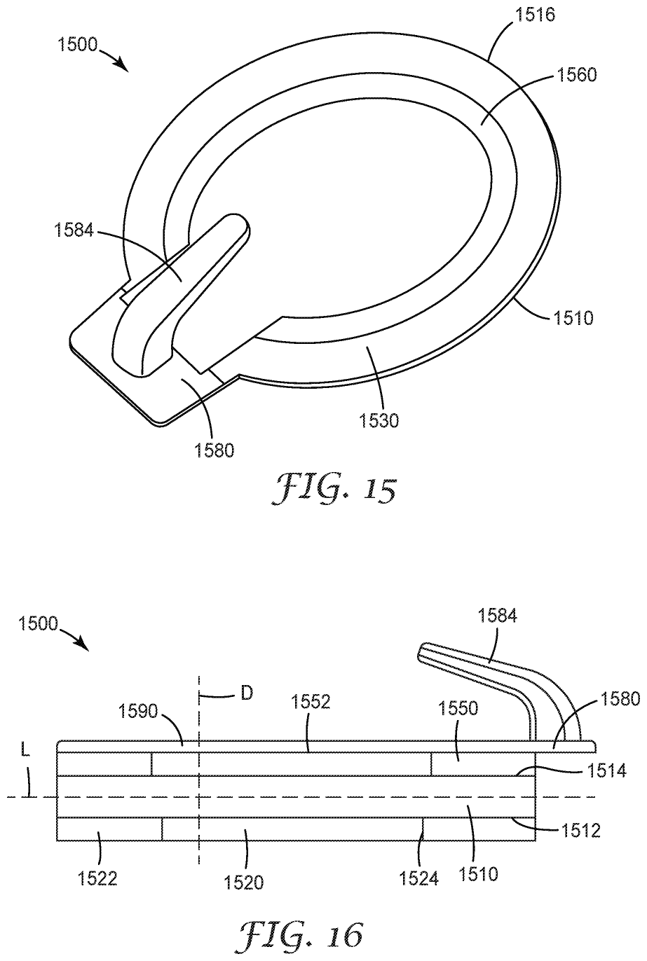

FIGS. 14A-14C are, respective, perspective, front, and rear schematic views of an exemplary mounting assembly embodiment 1400 including two mounting devices. Mounting assembly 1400 is substantially similar to the mounting assembly of FIG. 3A-3D except that it includes six mounting devices 1430 and it has an elongate rectangular shape and it lacks a tab portion. A non-adhesive region 1422 is preferably adjacent to or aligned with one or more, and preferably all of, mounting devices 1422.

FIGS. 15 and 16 are, respectively, perspective and cross-sectional views of an exemplary mounting assembly 1500 featuring a mounting device 1530 that is at least coextensive with a backing 1510.

Adhesive mounting assembly 1500 includes a backing 1510 including first and second opposed major surfaces 1512 and 1514. A mounting device 1530 is disposed adjacent the second major surface 1514 of the backing 1510. Mounting device 1530 includes a hook portion 1580 with a hook 1584 and a flange portion 1590. In the embodiment of FIGS. 15-16, a rear surface of flange portion 1590 and hook portion 1580 attaches to or mates with a complementary portion of backing 1510. The flange portion 1590 is at least substantially coextensive with the second major surface 1514 of backing 1510. In other embodiments, at least a portion of the flange portion 1590 and/or the hook portion 1580 can extend beyond an edge of the backing 1510, and vice versa.

An adhesive region 1520 of first major surface 1512 is coated with an adhesive. The illustrated embodiment of adhesive region 1520 includes a generally ovular shape, however, an adhesive region 1520 according to the present disclosure can take the form of any shape.

A non-adhesive region 1522 of first (or rear) major surface 1512 of backing 1510 lacks adhesive functionality and/or is not significantly adhesive. The non-adhesive region 1522 partially surrounds the adhesive region 1520, defining a boundary 1524 between the adjacent regions 1520, 1522. As depicted, the non-adhesive region 1522 extends from the boundary 1524 to the perimeter 1516 of the backing 1510.

The mounting device 1530 is coupled to the second major surface 1514 of the backing by at least an adhesive region 1550 coated with an adhesive. The adhesive region 1550 on the second (front) surface 1514 is at least coextensive with and corresponds in geometry to non-adhesive region 1522 on the first major surface 1512. Similarly, the non-adhesive region 1552 on the front surface 1514 is at least coextensive with and corresponds to the adhesive region 1520 on the rear surface 1512 of the backing 1510. That is, the adhesive/non-adhesive character of a given region on a major surface will have its opposite disposed across the backing on the opposing major surface. Accordingly, the disposition of the adhesive/non-adhesive regions on the rear major surface 1512 is essentially inverse to the disposition of adhesive/non-adhesive regions on the front major surface 1514. This arrangement assures that no adhesive regions overlap with one another along an axis “L” extending through the thickness of the backing and normal to the major surface planes (see FIG. 16). Without wishing to be bound by theory, visible damage is often likely to occur during or after removal if a direct adhesive connection through the thickness of the adhesive article can be made between the wall surface (i.e., adhered) and the mounting device. By disrupting that link through non-overlapping (at least in parallel planes) adhesive regions, the present inventors found that the damage to various wall surfaces can be reduced or eliminated.

When distributed in inverse relationship on opposing sides of the backing, no adhesive region or element is coplanar with another adhesive region in a plane “P” extending through first and second major surfaces and substantially perpendicular the longitudinal axis “L” of the backing. Similarly, no non-adhesive region or element is coplanar with another non-adhesive region in a plane “P” extending through first and second major surfaces and substantially perpendicular the longitudinal axis “L” of the backing.

In presently preferred implementations of the present disclosure, non-adhesive region 1552 on second major surface 1514 comprises a similar geometry of larger surface area than corresponding adhesive region 1520 on the rear surface 1512. The geometric offset creates an overlap boundary 1560 (made visible in FIG. 15). The use of an overlap boundary 1560 can allow for manufacturing tolerance of equipment used to create the requisite regions, and can thus help ensure there is no adhesive having a direct path from the mounting device 1530 to the wall surface or other adherend.

Depending on e.g., the particular user, the selected adherend, and the construction of the mounting device, the present inventors have discovered that having a mounting device that is at least coextensive with the backing can improve the ability of a user to secure the assembly to a substrate. The mounting device can protect the backing from wrinkling or other deformation as the user determines the desired position of the assembly on the substrate; whereas a larger film having a relatively smaller mounting device could, in certain circumstances, be more susceptible to deformation.

Furthermore, the use of a mounting device that is at least coextensive if not larger than the backing may also improve the weight-bearing capability of a mounting assembly for objects or hook designs inclined to generate a load in directions that are not generally parallel or coplanar with a major plane of the backing.

Many changes may be made to the specific embodiment shown in FIGS. 15 and 16. For example, the mounting device can be any desired mounting device. Multiple mounting devices can be present. The shape and size of the mounting device and/or backing can be any desired shape or size.

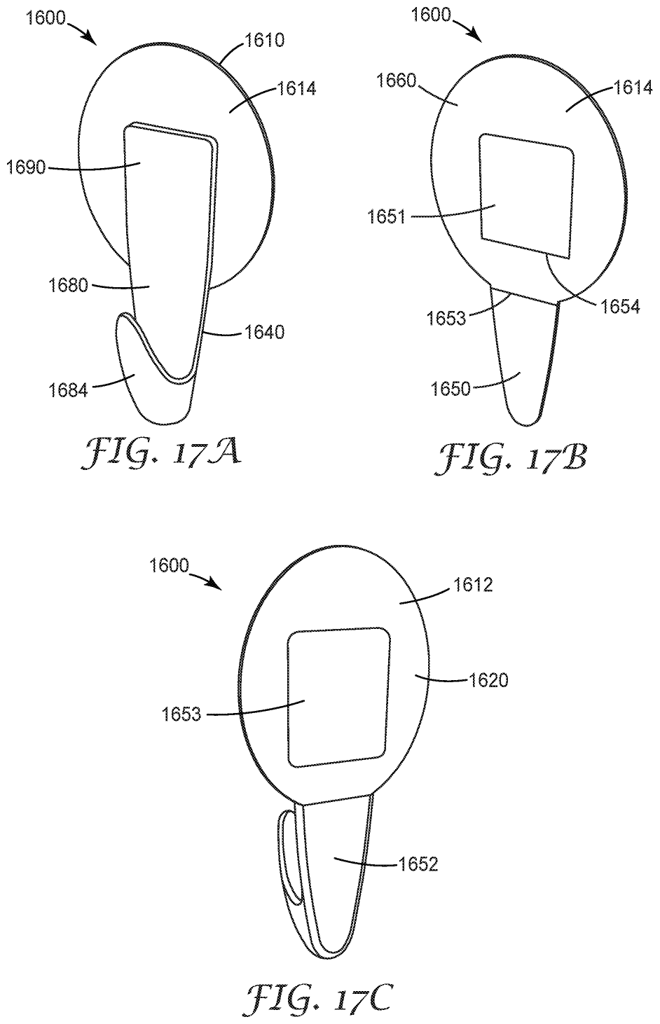

FIGS. 17A-17C depict another exemplary embodiment of a mounting assembly 1600 featuring inversely disposed adhesive and non-adhesive regions.

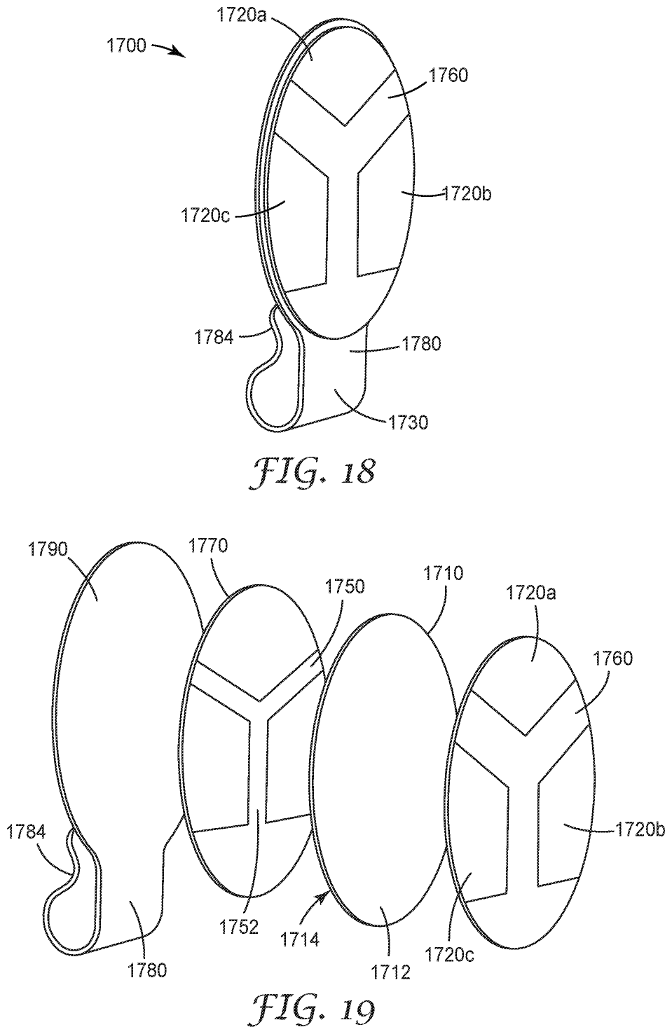

Adhesive mounting assembly 1600 includes a backing 1610 including first and second opposed major surfaces 1612 and 1614. A mounting device 1640 is disposed adjacent the second major surface 1614 of the backing 1610. The mounting device 1640 includes a hook portion 1680 and a generally rectangular flange portion 1690. In the embodiment of FIGS. 17-18, a rear surface of hook portion 1680 attaches to or mates with a complementary tab portion 1619 of backing 1610. The hook portion 1680 extends beyond the edges of the complementary tab portion 1619, while the backing 1610 extends beyond the edges of the flange portion 1690. In other contemplated embodiments, the backing 1610 can be coextensive with at least one of the hook and flange portions 1680, 1690. In yet another embodiment, both the flange and hook portions extend beyond the edges of the backing 1610.

The mounting device 1640 is coupled to the second major surface 1614 of the backing by at least a first adhesive region 1650 and a second adhesive region 1651, each coated with an adhesive. The first adhesive region 1650 on the second (front) surface 1614 corresponds in geometry to the hook portion 1680 of the mounting device 1640. The second adhesive region 1651 is spaced from the first adhesive region 1650 and corresponds in geometry to a selected area of the flange portion 1690. The first and second adhesive regions are separated by a non-adhesive region 1660, which surrounds the second adhesive region 1651 and lacks adhesive functionality and/or is not significantly adhesive. As depicted, the non-adhesive region 1660 extends from the boundary 1654 with second adhesive region 1651 to the perimeter 1616 of the backing 1610 and to the boundary 1653 of the first adhesive region 1650.

The illustrated embodiment of the first adhesive region 1620 includes a generally parabolic shape corresponding to the hook portion 1680 of the mounting device and the complementary tab portion 1619. The second adhesive region 1651 includes a tetrahedral shape, however, a given adhesive region 1650, 1651 on the front surface can take the form of any shape.

The first (rear) major surface 1612 of the backing 1610 includes least a first non-adhesive region 1622 and a second non-adhesive region 1623, each lacking adhesive functionality and/or not being significantly adhesive. The first non-adhesive region 1622 is coextensive with and corresponds in geometry to the first adhesive region 1650 on the front surface 1614, while the second non-adhesive region 1623 is coextensive with and corresponds in geometry to the second adhesive region 1651 on the front surface 1614. Similarly, the adhesive region 1620 on the rear surface 1612 corresponds to the non-adhesive region 1660 on the front surface 1614. That is, the adhesive/non-adhesive character of a given region on a major surface will have its opposite disposed across the backing on the opposing major surface. Accordingly, the disposition of the adhesive/non-adhesive regions on the rear major surface 1612 is essentially inverse to the disposition of adhesive/non-adhesive regions on the front major surface 1614. This arrangement assures that no adhesive regions overlap with one another along an axis extending through the thickness of the backing and normal to the major surface planes.

The use of at least two adhesive regions on the front surface can advantageously improve the capacity of the assembly 1600 to hold more weight (load/area) for a longer period of time when adhered or attached to a surface.

Many changes may be made to the specific embodiment shown in FIGS. 17A-17C. For example, the mounting device can be any desired mounting device. Multiple mounting devices can be present. The shape and size of the mounting device and/or backing can be any desired shape or size.

FIGS. 18 and 19 are, respectively, a rear perspective and an exploded, disassembled view of another exemplary mounting assembly 1700 featuring inversely disposed adhesive and non-adhesive regions and a deadening material to control adhesive functionality.

Adhesive mounting assembly 1700 includes a backing 1710 including first and second opposed major surfaces 1712 and 1714. A mounting device 1730 is disposed adjacent the second major surface 1714 of the backing 1710. Mounting device 1730 includes a hook portion 1780 with a hook 1784 and a flange portion 1790. In the embodiment of FIGS. 18-19, a rear surface of flange portion 1790 attaches to or mates with a complementary portion of backing 1710. The flange portion 1790 is at least substantially coextensive with the second major surface 1714 of backing 1710.

A layer of adhesive 1720 is applied to the first major surface 1712, while a layer of adhesive 1750 is applied to the second major surface 1714. As depicted, each layer of adhesive 1720, 1750 is continuous and coextensive with the backing 1710, though other constructions (e.g., an adhesive layer that is not coextensive with the backing) are possible. A first deadening layer 1760 featuring a first arranged pattern of deadening material is disposed on a major surface of the adhesive layer 1720. A second deadening layer 1770, featuring a second geometry inverse to the first geometry, is disposed between the mounting device 1730 and a major surface of the second adhesive layer 1750.

The first deadening layer 1760 is arranged to create discrete adhesive regions on adhesive layer 1720. The deadening layer 1760 includes a generally Y-shaped pattern filled with deadening material. This pattern, when disposed on the adhesive layer, will create discreet adhesive regions and non-adhesive regions as described in further detail below. The non-adhesive region created will then include both adhesive and deadening material. Accordingly, if a deadening material is used in assemblies of the present disclosure, non-adhesive elements can include an adhesive disposed between a backing and a deadening material.

The geometry and arrangement of the deadening material in the second deadening layer 1770 corresponds to the discrete adhesive regions 1720a-1720c. The Y-shaped pattern so created lacks a deadening material, and so will assist in defining the adhesive region on the front major surface 1714 of the backing 1710.

In presently preferred implementations, the deadening layer 1760 is disposed on the surface of the adhesive layer 1720 opposite the rear surface 1712 of the backing 1710. Under certain circumstances and constructions, a deadening layer or material applied directly to the backing will not allow the backing and/or the adhesive layer(s) to stretch in a manner sufficient to avoid damage to an adherend.

In presently preferred implementations of the present disclosure, the adhesive region 1752 on second major surface 1714 comprises a similar geometry of smaller total surface area than corresponding non-adhesive region 1720 on the rear surface 1712. The geometric offset creates an overlap boundary. The use of an overlap boundary can allow for manufacturing tolerance of equipment used to create the requisite regions, and can thus help ensure there is no adhesive having a direct path from the mounting device 1730 to the wall surface or other adherend.

The non-adhesive regions extend to the perimeter of the backing 1710, operating to vent air from the exterior of the adhesive/non-adhesive distribution inward. Under certain conditions, the ventilation can prevent the formation of a vacuum between an adhesive and the backing. Without wishing to be bound by theory, the creation of a vacuum can inhibit the separation of the non-adhesive regions from the backing, potentially resulting in additional, visible damage upon attempted removal.

Many changes may be made to the specific embodiment shown in FIGS. 18 and 19. For example, the mounting device can be any desired mounting device. Multiple mounting devices can be present. The shape and size of the mounting device and/or backing can be any desired shape or size.

Any of the embodiments shown or described above or herein can have any combination of the backings, adhesives, adhesive regions, non-adhesive regions, high and low stiffness and/or surface modulus regions, and/or mounting devices described below. For example, the mounting device can overlap or be adjacent to multiple or a plurality of non-adhesive regions.

Backing

The backing can be made of any desired material. Representative examples of materials suitable for the backing can include, for example, polyolefins, such as polyethylene, including high density polyethylene, low density polyethylene, linear low density polyethylene, and linear ultralow density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadienestyrene copolymers, and ethylene/propylene copolymers; acrylic polymers and copolymers; polyurethanes; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used.

In some embodiments, the backing is or includes a composite foam that includes a flexible polymeric foam layer, a first film laminated to a first major surface of the foam layer, and a second film laminated to a second, opposite major surface of the foam layer. Adhesive(s) can be attached to the films to form a structure of adhesive-film-foam-film-adhesive. The flexible polymeric foam layer can be chosen to optimize conformability and resiliency properties which are helpful when the mounting assembly is to be adhered to surfaces having surface irregularities. Such is the case with a typical wall surface. An exemplary flexible polymeric foam layer is commercially available under the trade designation “Command” from Minnesota Mining and Manufacturing Company (“3M”) of St. Paul, Minn. In some embodiments, the flexible polymeric foam layer of the flexible backing layer can include polyolefin foams which are available under the trade designations “Volextra” and “Volara” from Voltek, Division of Sekisui America Corporation, Lawrence, Mass. In some embodiments, the backing is metal or metal-like. In some embodiments, the backing is wood or wood-like.

The backing can be or include any of the materials or backings described in WO Publication No. 2015/195344 (Runge et al.). In particular embodiments, the backing can include the multilayer films featuring a core and one or more skin layers as described in PCT Application No. US2017/016039 (Runge et al.).

The backing layer can be a single layer or a multi-layer construction. In some embodiments, two or more sub-layers can be co-extruded so as to form the backing. In some embodiments, the backing is flexible.

Some embodiments include dyes or pigments in the backing layer. Some embodiments include at least one tackifier in at least one layer of the backing. Some embodiments include a plasticizing oil in one or more layers of the backing.

The backing can be any desired shape including, for example, square, rectangle, triangular, polygon, circular, quadrilateral, trapezoidal, cylindrical, half-circular, star-shaped, half-moon shaped, tetrahedral, etc. Some additional exemplary adhesive mounting system shapes are shown in FIGS. 10-13. In some embodiments, the backing has a size of between about 70 mm² and about 10,000,000 mm². In some embodiments, the backing has a size of between about 100 mm² and about 5,000 mm².

In some embodiments, the backing has a Young's modulus of between about 100 psi and about 100,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, the backing has a modulus of elasticity and/or a modulus of secant of between about 100 psi and about 15,000 psi as determined by at least one of ASTM D638-14 and ASTM D412-06a. In some embodiments, the backing has a modulus ranging between 100 psi and 15000 psi. In some embodiments the modulus is greater than 100 psi, greater than 500 psi, greater than 1000 psi. In some embodiments the backing modulus is less than 15000 psi, less than 10000 psi, less than 8,000 psi, less than 5,000 psi, less than 3,500 psi, less than 2000 psi, and less than 1500 psi.

In some embodiments, the backing has a thickness of between about 0.1 mils and about 100 mils. In some embodiments, the backing has a thickness of greater than 1 mil, greater than 2 mils, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

The adhesive article or backing can include a non-tacky tab, which can be grasped and pulled by a user to stretch and/or peel the tape during the removal process, so as to remove the tape from the object or substrate to which it has been affixed. The non-tacky tab can be an extension of the backing material or a detackified portion of the adhesive. The non-tacky tab can be formed from a tacky adhesive substrate using any known method of producing a non-tacky area including, e.g., applying a detackifying or deadening material or process to the adhesive to render it non-tacky. Where present, the tab can be of any shape or size. The tab can be made of the same material as the backing or of a different material. In some embodiments, the tab has an area that is between about 5% and about 25% of the total area of the adhesive mounting assembly. In some embodiments, there is no obvious tab and the mounting device or hook act as the tab

In some embodiments, the adhesive mounting assembly further includes a release liner adjacent to the adhesive region(s). The release liner protects the adhesive during manufacturing, transit, and before use. When the user desires to use the adhesive article, the user can peel or remove the release liner to expose the adhesive. The adhesive article can also include one or more liners disposed on the exposed surface(s) of the adhesive composition to protect the adhesive until use. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone or silicone polycoated paper. The release liner can be printed with lines, brand indicia, or other information.

Adhesive

The adhesive can include any adhesive having the desired properties. The adhesive can be peelable or stretch releasable and peelable.

In some embodiments, the adhesive articles of the present disclosure can be removed from a substrate or surface without causing damage. As used herein, the term “without causing damage” or “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

In some embodiments, the peelable adhesive is a pressure sensitive adhesive. A general description of useful pressure-sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure-sensitive adhesive. Exemplary pressure-sensitive adhesives utilize one or more thermoplastic elastomers, e.g., in combination with one or more tackifying resins. In some embodiments, the adhesive is not a pressure sensitive adhesive.

In some embodiments, the peelable adhesive layer can include at least one of rubber, silicone, or acrylic based adhesives. In some embodiments, the peelable adhesive layer can include a pressure-sensitive adhesive (PSA). In some embodiments, the peelable adhesive can include tackified rubber adhesives, such as natural rubber; olefins; silicones, such as silicone polyureas or silicone block copolymers; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above. The adhesive can be, for example, any of the adhesives described in any of the following patent applications, all of which are incorporated by reference herein: PCT Patent Publication Nos. 2015/035556, 2015/035960, and US 2015/034104.

In some embodiments, the adhesive includes a tackifier. Some exemplary tackifiers include at least one of polyterpene, terpene phenol, rosin esters, and/or rosin acids.

In some embodiments, the peelable adhesive is a flowable adhesive that can be coated onto the backing. In some embodiments, the peelable adhesive is a more solid adhesive as is generally described in, for example, German Patent No. 33 31 016.

In some embodiments, adhesion properties of the adhesive can range from 0.1 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a sheer strength of, for example, 1-20 pounds per square inch as measured by ASTM Test Method D3654M-06.

In some embodiments, the adhesive article can be peeled from at least one of the second terminal end, the first side, or the second side. In some embodiments, the adhesive article can be peeled from at least two of the second terminal end, the first side, or the second side.

In some embodiments, the peelable adhesives are tailored to achieve peel with no or minimal damage. Exemplary methods and articles for doing so are described in, for example, U.S. Pat. No. 6,835,452 and Patent Application No. 62/289,585, filed by the present assignee.

In some embodiments, the peelable adhesive has a Tg of between about −80 degrees Celsius and about 20 degrees Celsius. In some embodiments, the peelable adhesive has a Tg of between about −70 degrees Celsius and about 0 degrees Celsius. In some embodiments, the peelable adhesive has a Tg of between about −60 degrees Celsius and about −20 degrees Celsius. In some embodiments, the peelable adhesive has a Tg of greater than −80 degrees Celsius, greater than −70 degrees Celsius, greater than −60 degrees Celsius, greater than −50 degrees Celsius, greater than −40 degrees Celsius, or great than −30 degrees Celsius. In some embodiments, the peelable adhesive has a Tg of less than 20 degrees Celsius, 10 degrees Celsius, 0 degrees Celsius, −10 degrees Celsius, −20 degrees Celsius, or −30 degrees Celsius.

In some embodiments, the peelable adhesive has a storage modulus at 25° C. ranging from 300,000 Pa to 5,000,000 Pa at 25° C.

In some embodiments, the adhesive article exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive article exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments, the backing can prevent or minimize substrate damage by lowering the peel force through elongation of the backing which aids in adhesive removal. In some embodiments this can occur at peel angles ranging from 0-180 degrees. In some embodiments, when the final tape construction is peeled from the adherend at 90-180 degrees the backing elongates less than 1% during peeling. In some embodiments, when the final tape construction is peeled from the adherend at 90-180 degrees the backing elongates less than 5% during peeling. In some embodiments, when the final tape construction is peeled from the adherend at 90-180 degrees the backing elongates less than 10% during peeling. In some embodiments, when the final tape construction is peel from an adherend at 90-180 degrees the backing elongates more than 10% strain, and elastically recovers more 80% of that deformation. In some embodiments, when the final tape construction is peel from an adherend at 90-180 degrees the backing elongates more than 10% strain, and elastically recovers more 90% of that deformation. In some embodiments, when the final tape construction is peel from an adherend at 90-180 degrees the backing elongates more than 10% strain, and elastically recovers more 95% of that deformation. In some embodiments, when the final tape construction is peel from an adherend at 90-180 degrees the backing elongates more than 10% strain, and elastically recovers more 99% of that deformation.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments, have a haze of no greater than 20%.

Adhesive Regions, Areas, or Portions

The adhesive region can have any desired size. In some embodiments, the adhesive region has a size of between about 60 mm² and about 500,000 mm². In some embodiments, the adhesive region has a size that is greater than 60 mm² or greater than 85 mm² or greater than 100 mm² or greater than 150 mm² or greater than 200 mm² or greater than 300 mm² or greater than 400 mm² or greater than 500 mm² or greater than 600 mm² or greater than 750 mm² or greater than 1000 mm² or greater than 1500 mm² or greater than 2000 mm² or greater than 2500 mm² or greater than 3000 mm² or greater than 3500 mm² or greater than 4000 mm² or greater than 4500 mm² or greater than 5000 mm² or greater than 5500 mm² or greater than 6000 mm² or greater than 10,000 mm² or greater than 50,000 mm² or greater than 100,000 mm² or greater than 200,000 mm² or greater than 300,000 mm² or greater than 400,000 mm². In some embodiments, the adhesive region has a size that is less than 100 mm² or less than 200 mm² or less than 300 mm² or less than 400 mm² or less than 500 mm² or less than 600 mm² or less than 750 mm² or less than 1000 mm² or less than 1500 mm² or less than 2000 mm² or less than 2500 mm² or less than 3000 mm² or less than 3500 mm² or less than 4000 mm² or less than 4500 mm² or less than 5000 mm² or less than 5500 mm² or less than 6000 mm² or less than 10,000 mm² or less than 50,000 mm² or less than 100,000 mm² or less than 200,000 mm² or less than 300,000 mm² or less than 400,000 mm²

The adhesive region can have any desired shape that provides the desired properties and/or performance. In some embodiments, the adhesive region includes a shaped portion and an unshaped portion. In some embodiments, the shaped portion has a shape selected from at least one of rectangular, pentagonal, hexagonal, triangular, quadrilateral, curved, star-shaped, conical, trapezoidal, polygonal, teardrop, and arrow-shaped. In some embodiments, the shaped portion has a shape at least a portion of which is curved. In some such embodiments, a radius of curvature of the curved shape is between about 2.5 mm and about 25,000 nm.

In some embodiments, the adhesive region comprises between about 0.01% and about 99% of a total adhesive article area. In some embodiments, the adhesive region comprises between about 35% and about 75% of a total article area.

In some embodiments, the adhesive region, area, or portion can include two linear boundaries. These two linear boundaries can terminate in, for example, a point or plateau. In some embodiments, the linear boundaries intersect the sides of the backing. In some embodiments, the angle at which the linear boundary intersects the first or second side is between about 10 degrees and about 179 degrees. In some embodiments, the angle at which at least one of the linear boundaries intersects the first or second side is at least about 15 degrees or at least about 20 degrees or at least about 25 degrees or at least about 30 degrees or at least about 35 degrees or at least about 40 degrees or at least about 45 degrees or at least about 50 degrees or at least about 55 degrees or at least about 60 degrees or at least about 65 degrees or at least about 70 degrees or at least about 75 degrees or at least about 80 degrees or at least about 85 degrees or at least about 90 degrees or at least about 95 degrees or at least about 100 degrees or at least about 105 degrees or at least about 110 degrees or at least about 115 degrees or at least about 120 degrees or at least about 125 degrees or at least about 130 degrees or at least about 135 degrees or at least about 140 degrees or at least about 145 degrees or at least about 150 degrees or at least about 155 degrees or at least about 160 degrees or at least about 165 degrees or at least about 170 degrees. In some embodiments, the angle at which at least one of the linear boundaries intersects the first or second side is less than about 45 degrees or less than about 50 degrees or less than about 55 degrees or less than about 60 degrees or less than about 65 degrees or less than about 70 degrees or less than about 75 degrees or less than about 80 degrees or less than about 85 degrees or less than about 90 degrees or less than about 95 degrees or less than about 100 degrees or less than about 105 degrees or less than about 110 degrees or less than about 115 degrees or less than about 120 degrees or less than about 125 degrees or less than about 130 degrees or less than about 135 degrees or less than about 140 degrees or less than about 145 degrees or less than about 150 degrees or less than about 155 degrees or less than about 160 degrees or less than about 165 degrees or less than about 170 degrees or less than about 175 degrees or less than about 180 degrees or less than about 185 degrees or less than about 190 degrees. In some embodiments the first and second linear boundaries intersect the first and second sides at the same angle. In some embodiments the first and second linear boundaries intersect the first and second sides at different angles. In some embodiments, the first and second linear boundaries each have a length, and the length is approximately the same. In some embodiments, the first and second linear boundaries each have a length, and the length differs.

Non-Adhesive Regions, Areas, or Portions

As stated above, as used herein, the term “non-adhesive regions” refers to one or more regions of the adhesive article having a reduction in adhesive properties (peel adhesion or tack) as compared to the adhesive region(s) ranging from about 1% to about 100% as measured by ASTM D3330/3330M-04 (for peel adhesion) or ASTM D2979-01 (2009) (probe tack).

In some embodiments, the one or more non-adhesive regions have a reduction in adhesive properties (peel adhesion or tack) as compared to the adhesive region(s) of at least about 5% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 10% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 15% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 20% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 30% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 40% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 50% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 60% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 70% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 80% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 90% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 95% as measured by ASTM D3330/3330M-04 (for peel adhesion) or ASTM D2979-01 (2009) (probe tack).

In some embodiments, the non-adhesive area(s) have a location and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled.

The non-adhesive region can have any desired size. In some embodiments, the non-adhesive region has a size of between about 60 mm² and about 500,000 mm². In some embodiments, the non-adhesive region has a size that is greater than 60 mm² or greater than 85 mm² or greater than 100 mm² or greater than 150 mm² or greater than 200 mm² or greater than 300 mm² or greater than 400 mm² or greater than 500 mm² or greater than 600 mm² or greater than 750 mm² or greater than 1000 mm² or greater than 1500 mm² or greater than 2000 mm² or greater than 2500 mm² or greater than 3000 mm² or greater than 3500 mm² or greater than 4000 mm² or greater than 4500 mm² or greater than 5000 mm² or greater than 5500 mm² or greater than 10,000 mm² or greater than 50,000 mm² or greater than 100,000 mm² or greater than 200,000 mm² or greater than 300,000 mm² or greater than 400,000 mm². In some embodiments, the non-adhesive region has a size that is less than 100 mm² or less than 200 mm² or less than 300 mm² or less than 400 mm² or less than 500 mm² or less than 600 mm² or less than 750 mm² or less than 1000 mm² or less than 1500 mm² or less than 2000 mm² or less than 2500 mm² or less than 3000 mm² or less than 3500 mm² or less than 4000 mm² or less than 4500 mm² or less than 5000 mm² or less than 5500 mm² or less than 6000 mm² or less than 10,000 mm² or less than 50,000 mm² or less than 100,000 mm² or less than 200,000 mm² or less than 300,000 mm² or less than 400,000 mm².

The non-adhesive region can have any desired shape that provides the desired properties and/or performance. In some embodiments, the non-adhesive region has a shape selected from at least one of rectangular, pentagonal, hexagonal, triangular, quadrilateral, curved, star-shaped, conical, trapezoidal, polygonal, teardrop, and arrow-shaped. In some embodiments, at least a portion of the non-adhesive region is curved. In some such embodiments, a radius of curvature of the curved shape is between about 2.5 mm and about 25,000 nm. In some embodiments, the non-adhesive regions form a pattern.

In some embodiments, the non-adhesive region comprises between about 0.01% and about 99% of a total adhesive article area. In some embodiments, the non-adhesive region comprises between about 35% and about 75% of a total article area.

The non-adhesive regions, areas, or portions can be formed in any desired way. For example, in some embodiments, the non-adhesive region does not include an adhesive. Such embodiments can lack adhesive because no adhesive has been applied or because adhesive has been removed. For example, an adhesive may be coated on a major surface, and then a portion of the adhesive or the major surface may be cut away or otherwise removed. Alternatively, the adhesive can be pattern coated.

In other embodiments, a deadening layer is applied over at portion of the adhesive region to form a non-adhesive region. The deadening material decreases or eliminates the adhesiveness of the adhesive in the adhesive area. Exemplary deadening materials include, for example, glass bubbles, a film, a clear ink, a liquor, and/or an adhesive with lower adhesion properties. In some embodiments, the deadening layer has a thickness of between about 1 nm and about 1000 microns. In some embodiments, the deadening layer has a thickness of between about 1 nm and about 100 microns. In some embodiments, the deadening layer has a thickness of between about 100 nm and about 50 microns. In some embodiments, the adhesive in the non-adhesive area is treated in a way that decreases or eliminates its adhesiveness. Some exemplary treatments include, for example, radiation, UV exposure, e-beam, or other means to crosslink or detackify the adhesive. In some embodiments, a second adhesive with lower adhesion is present in the non-adhesive area.

High and Low Stiffness Regions

As used herein, the term “stiffness” refers to the bending resistance of a body when forces are applied to it. High stiffness generally means that large forces produce small deflections or displacements. Stiffness is dependent on, for example, Young's modulus and the cross-sectional thickness. The stiffness of the adhesive mounting assembly is defined by the combination of cross-sectional thickness and Young's modulus. Exemplary mounting assembly thicknesses include those between about 0.1 mils and about 100 mils. Exemplary Young's Modulus's of mounting assemblies described herein are between about 100 PSA and about 15,000 PSI measured according to ASTM D638.

As used herein, the term “high stiffness region” refers to a region having a stiffness that is at least about 5% greater than a “low stiffness region” of the adhesive mounting assembly. In some embodiments, the high stiffness region has a stiffness that is between about 5% and about 10,000% greater than the stiffness in a low stiffness region. In some embodiments the high stiffness region has a stiffness that is at least 50% greater than the stiffness in the low stiffness region. In some embodiments the high stiffness region has a stiffness that is at least 100% greater than the stiffness in the low stiffness region. In some embodiments the high stiffness region has a stiffness that is at least 1000% greater than the stiffness in the low stiffness region. In some embodiments the high stiffness region has a stiffness that is at least 5000% greater than the stiffness in the low stiffness region.

In some embodiments, the lower stiffness region(s) has a Young's modulus of between about 600 PSI to about 1500 PS as measured by ASTM D638. In some embodiments, the higher stiffness region has a Young's modulus of between about 660 PSI and about 2000 PSI measured according to ASTM D638-14.

In some embodiments, the higher stiffness region has a Young's modulus of at least about 100 psi measured according to ASTM D638-14 or ASTM D412-06a. In some embodiments, the higher stiffness region has a Young's modulus of no greater than about 30,000,000 psi measured according to ASTM E111-04. In some embodiments, the higher stiffness region has a Young's modulus of between about 50,000 psi to about 200,000 psi measured according to ASTM D638-14 or ASTM D412-06a.

In some embodiments, the higher stiffness region has a stiffness that is at least 1.01 times greater than the stiffness or modulus of the lower stiffness or section modulus region. In some embodiments, the higher stiffness or section modulus region has a stiffness of section modulus that is about 1.5, about 1.75, about 2, about 3, about 4, about 5, about 6, about 7, about 8, about 9, about 10, about 20, about 30 about 40, about 50, about 60, about 70, about 80, about 90, about 100, about 500, about 1000, about 5,000, about 10,000, about 20,000, about 30,000, about 40,000, or about 50,000 times greater than the stiffness of the lower stiffness region.

Mounting Devices

The mounting device can be made of any desired material, size, or shape. Some exemplary materials include plastic, metal, rubber, glass, wood, ceramic, fabric, etc. Exemplary mounting devices include hooks, clips, magnets, detachable mechanical fasteners, snaps, and loops.

Any known mounting device can be used including, for example, any of those described herein. In some embodiments, the mounting device resembles a nail. In some embodiments, the mounting device has a single outward projection to act as a hanging surface. In some embodiments, the mounting device has multiple outward projections to act as a hanging surface. In some embodiments, the mounting device has is molded into a shape that can hold one or more items within such as but not limited to a box or caddy. In some embodiments, the mounting device is a shelf, ledge, or rack. In some embodiments, the mounting device is a bar wherein the bar can be straight or curved or substantially a ring wherein the bar can be mounted parallel or normal to the substrate surface. In some embodiments, the mounting device uses multiple methods for mounting or hanging items. Any of the following mounting devices can be suitable for use with the adhesive article of the present disclosure: Application No. 62/289,474 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.). The mounting device may be any object to be mounted to a substrate.

In some embodiments, the mounting device is made from thermoplastic polymers. In some embodiments, the mounting device is made from thermoset polymers. In some embodiments, the mounting device is made using polyolefin materials. In some embodiments, the mounting device is made using polycarbonate materials. In some embodiments, the mounting device is made using high-impact polystyrene. In some embodiments, the mounting device is made using acrylonitrile-butadiene-styrene (ABS) terpolymers. In some embodiments, the mounting device is made using two or more polymeric materials. In some embodiments, the mounting device is made from metal. In some embodiments, the mounting device is made from stainless steel. In some embodiments, the metal is painted, glazed, stained, brushed, or coated to alter its appearance. In some embodiments, the mounting device is made from ceramic. In some embodiments, the mounting device is made from glazed ceramic. In some embodiments, the mounting device is made from unglazed ceramic. In some embodiments, the mounting device is comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the mounting device is made using two or more materials from the list above. In some embodiments, the mounting device is made from two pieces that are reversibly or irreversibly attached, joined, or welded together.

Adhesive Article

Some adhesive articles of the present disclosure have excellent shear strength. Some embodiments of the present disclosure have a shear strength of greater than 1800 minutes as measured according to ASTM D3654M. Some embodiments of the present disclosure have shear strength of greater than 10,000 minutes as measured according to ASTM D3654M.

In some embodiments, the adhesive article has a thickness that is between about 0.1 mil and about 250 mils. In some embodiments, the thickness is greater than 0.1 mil, greater than 1 mil, greater than 5 mils, greater than 10 mils, greater than 15 mils, greater than 20 mils, greater than 25 mils, greater than 50 mils, greater than 75 mils, greater than 100 mils, greater than 150 mils, greater than 200 mils. In some embodiments, the thickness is less than 250 mils, less than 225 mils, less than 200 mils, less than 175 mils, less than 150 mils, less than 100 mils, less than 75 mils, less than 50 mils, less than 25 mils, less than 20 mils, less than 15 mils, or less than 10 mils.

In some embodiments, the adhesive article has a peel initiation force of between about 0.1% and 300% of the average peel force of the adhesive article. In some embodiments, the peel force is below 30 oz/inch at all points along the adhesive article.

In some embodiments, the adhesive articles of the present disclosure exhibit enhanced conformability to a substrate or surface than prior art adhesive mounting articles. In some embodiments, the adhesive articles of the present disclosure hold more weight when adhered or attached to a substrate or surface than prior art adhesive mounting articles. In some embodiments, the adhesive articles of the present disclosure hold more weight (load/area) for a longer period of time when adhered or attached to a substrate or surface than prior art adhesive mounting articles. In some embodiments, the adhesive articles of the present disclosure remain adhered to a textured, rough, or irregular surface for a longer period of time than prior art adhesive mounting articles. In some embodiments, the adhesive articles of the present disclosure hold a higher amount of weight when adhered to a textured, rough, or irregular surface than prior art adhesive mounting articles.

In some embodiments, the adhesive article is substantially optically clear. Some embodiments have a light transmission of at least about 50% as measured using the method set forth in ASTM D1003-13. Some embodiments have a light transmission of at least about 75% as measured using the method set forth in ASTM D1003-13. Some embodiments have a haze of no greater than 40%. Some embodiments, have a haze of no greater than 20% as measured using the method set forth in ASTM D1003-13

In some embodiments, the adhesive article is substantially opaque

In some embodiments, the adhesive article has a thickness that is between about 2 mil and about 250 mils. In some embodiments, the thickness is greater than 3 mils, greater than 4 mils, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

In some embodiments, the peel force is below 30 oz/inch at all points along the adhesive article. Some adhesive assemblies of the present disclosure have a lower peel force to make the adhesive assembly easier to remove (e.g., a force between about 25 oz/in to about 50 oz/in). Some adhesive assembly of the present disclosure can have a higher peel force as to permit handling of the adhesive article by the user without accidental separation (e.g., a force between about 50 oz/in to 100 oz/in). Some embodiments of the present disclosure have a peel force between about 20 oz/in to 90 oz/in. Some embodiments of the present disclosure have a peel force between about 30 oz/in to 70 oz/in. Some adhesive articles of the present disclosure have an elongation at break of greater than 50% in at least one direction. Some adhesive assemblies of the present disclosure have an elongation at break of between about 50% and about 1200% in at least one direction.

In some embodiments, a force of between about 1N and about 50N per inch width is required to strain the adhesive article 10% in tensile elongation as measured according to ASTM D638-14 and/or ASTM D412-06a. In some embodiments, a force of between about 2N and about 30N per inch width is required to strain the adhesive article 10% in tensile elongation as measured according to ASTM D638-14 and/or ASTM D412-06a. In some embodiments, a force of between about 3N and about 15N per inch width is required to strain the adhesive article 10% in tensile elongation as measured according to ASTM D638-14 and/or ASTM D412-06a.

In some embodiments, the adhesive article has an elongation at break of at least 400%.

In some embodiments, the adhesive article can further include a separable connector. Some exemplary separable connectors are described in, for example, U.S. Pat. Nos. 6,572,945; 7,781,056; 6,403,206; and 6,972,141, all of which are incorporated by reference in their entirety herein.

Methods of Making

The adhesive mounting assemblies described herein can be made in various ways. In some embodiments, the adhesive can be directly coated onto a major surface of the backing. In other embodiments, the adhesive can be formed as a separate layer (e.g., coated onto a release liner) and then laminated to the backing.

The adhesive can be prepared using a variety of common methods for preparing adhesives. For example, the adhesive composition can be coated onto a release liner, coated directly onto a backing, or formed as a separate layer (e.g., coated onto a release liner) and then laminated to a backing. In some embodiments, the adhesive can be formed simultaneously with the backing. For example, a multilayer film consisting of at least two layers, at least one of which is an adhesive, can be coextruded. In some embodiments, the construction can be formed in a cast or blown film construction.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

In some embodiments, the application of the adhesive results in the desired non-adhesive areas being present on the major surface (e.g., the adhesive is pattern coated in the desired distribution, such that certain areas simply lack an adhesive). In other embodiments, a method of making includes a deadening material applied to the adhesive to create the requisite non-adhesive elements or regions. The deadening material may be applied to the backing before the adhesive is coated or otherwise affixed to the backing, such that the deadening material exists between the backing and the adhesive. In other embodiments, the deadening material is applied to a surface of the adhesive opposite the backing.

In certain embodiments, the deadening material (e.g., printing an ink pattern) can be deposited onto a release liner and transferred to an adhesive layer. In certain embodiments, the release liner is provided to cover and protect the external surface of adhesive, where the deadening material is at least partially embedded therein such that when the release liner is peeled from the adhesive, the deadening material remains with the adhesive. Peeling the release liner from the adhesive layer can simultaneously create selected areas having modified adhesive functionality.

Methods of Using

The adhesive mounting articles of the present disclosure can be used in various ways. In some embodiments, the backing is applied, attached to, or pressed into an adherend. In this way, the backing contacts the adherend. Where a release liner is present, the release liner is removed before the backing is applied, attached to, or pressed into the adherend. In some embodiments, at least a portion of the adherend is wiped with alcohol before the backing is applied, attached to, or pressed onto the adherend.

In some embodiments, to remove the backing from the adherend, at least a portion of the backing is peeled from the adherend. In embodiments where a tab is present, the user can grip the tab and use it to peel the backing from the adherend.

In some embodiments, removing the adhesive article from an adherend can be carried out by peeling the tape at a peel angle. In some embodiments, the peel angle is, for example, 90° or higher. In some embodiments, the peel angle can be lower than 90°. Removal at the appropriate peel angle can result in leaving no substantial or appreciable adhesive residue and in preventing the surface of the substrate from being damaged.

In some embodiments, to remove the backing from the adherend, at least a portion of the backing is peeled from the adherend. In embodiments where a tab is present, the user can grip the tab and use it to peel the backing from the adherend. In some embodiments, to remove the backing from the adherend, at least a portion of the backing is peeled and stretch released from the adherend.

In some embodiments, the surface to which the adherend is adhered is at least one of drywall, glass, tile, paint, veneer, wood, or other common household surfaces. In some embodiments, the surface is painted. In some embodiments the surface is painted with a low or no VOC paint.

Advantages of this disclosure are further illustrated by the following examples, but the particular materials and amounts thereof recited in these examples, as well as other conditions and details, should not be construed to unduly limit this invention. Unless otherwise indicated, all parts and percentages are by weight.

### Embodiments

1. An adhesive mounting assembly, comprising: a backing including opposing first and second major planar surfaces separated by a thickness; first and second adhesive regions on the first major planar surface of the backing; the first and second adhesive regions each exhibiting adhesive properties; and a mounting device adjacent to the second major planar surface of the backing; the mounting device having a mounting device area; wherein an area of the first major surface that is substantially aligned with or adjacent to at least a portion of the mounting device area is a non-adhesive region that lacks significant adhesive properties and wherein the non-adhesive region is between and/or adjacent to the first and second adhesive regions.

2. An adhesive mounting assembly, comprising: a backing including opposing first and second major planar surfaces separated by a thickness; a first adhesive region on the first major planar surface of the backing, the first adhesive region exhibiting adhesive properties; a second adhesive region on the first major planar surface of the backing, the second adhesive region exhibiting adhesive properties; a non-adhesive region on the first major planar surface of the backing, the non-adhesive region lacking significant adhesive properties and positioned between or adjacent the first and second adhesive regions; and a mounting device adjacent to the backing; wherein the non-adhesive region is adjacent to or aligns with the mounting device.

3. The adhesive mounting assembly of embodiment 1 or embodiment 2, wherein the mounting device is at least one of a hook, clip, magnet, detachable mechanical fastener, snap, loop, or detachable mechanical fastener.

4. The adhesive mounting assembly of any of the preceding embodiments, wherein the adhesive region includes an adhesive that includes at least one of natural rubber, synthetic rubber such as SBS, SIS, SEBS, acrylate, polyurethane, silicone, silicone block copolymers, and combinations thereof.

5. The adhesive mounting assembly of any of the preceding embodiments, wherein the adhesive region includes an adhesive that includes a tackifier selected from a list consisting essentially of terpene phenol, polyterpene, rosin esters, rosin acids, C5 tackifiers, and/or C9 tackifiers.

6. The adhesive mounting assembly of any of the preceding embodiments, wherein the backing includes at least one of plastic, metal, paper, nonwoven material, woven material, foam, and/or a filament reinforced material.

7. The adhesive mounting assembly of any of the preceding embodiments, wherein the backing is at least one of a single layer film or a multilayer film.

8. The adhesive mounting assembly of any of the preceding embodiments, wherein the

high stiffness region has a stiffness that is at least about 5% greater than the stiffness in a low stiffness region of the adhesive mounting assembly

9. The adhesive mounting assembly of any of the preceding embodiments, wherein the

backing exhibits an elastic recovery of 1-99% at 10% strain.

10. The adhesive mounting assembly of any of the preceding embodiments, wherein the

backing exhibits an elastic recovery of 1-99% at 20% strain

11. The adhesive mounting assembly of any of the preceding embodiments, wherein the non-adhesive region includes a deadening layer that substantially diminishes the adhesive properties of the adhesive and wherein the deadening layer is located adjacent to the adhesive.

12. The adhesive mounting assembly of embodiment 11, wherein the deadening layer has a thickness of between about 0.1 mil and about 10 mils.

13. The adhesive mounting assembly of any of embodiments 11-12, wherein the deadening layer comprises at least one of a coating, a film, ink, lacquer, and/or a chemical reaction initiated by radiation.

14. The adhesive mounting assembly of embodiment 1, wherein the non-adhesive region has a size, and wherein the non-adhesive region size is within 10% of a size of the mounting device.

15. The adhesive mounting assembly of embodiment 1, wherein the non-adhesive region adjacent to or aligning with the mounting device has a size, and wherein the size of the non-adhesive region is within 5% of a size of the mounting device and/or the mounting device area.

16. The adhesive mounting assembly of any of the preceding embodiments, wherein the non-adhesive region is larger than a size of the mounting device and/or a mounting device area.

17. The adhesive mounting assembly of embodiment 16, wherein the non-adhesive region is more than 10% larger than the size of the mounting device and/or the mounting device area.

18. The adhesive mounting assembly of any of the preceding embodiments, wherein the non-adhesive region is smaller than a size of the mounting device and/or a mounting device area.

19. The adhesive mounting assembly of embodiment 18, wherein the non-adhesive region has a size that is less than 95% of a size of the mounting device and/or the mounting device area.

20. The adhesive mounting assembly of any of the preceding embodiments, wherein the non-adhesive region has a size of between about 60 mm2 and about 100,000 mm2.

21. The adhesive mounting assembly of any of the preceding embodiments, wherein the non-adhesive region has a shape selected from at least one of rectangular, pentagonal, hexagonal, triangular, quadrilateral, curved, star-shaped, conical, trapezoidal, polygonal, teardrop, and arrow-shaped.

22. The adhesive mounting assembly of embodiment 21, wherein the adhesive is peelable.

23. The adhesive mounting assembly of any of the preceding embodiments, wherein the non-adhesive region comprises between about 10% and about 90% percent of a total adhesive article area.

24. The adhesive mounting assembly of any of the preceding embodiments, wherein the non-adhesive region comprises between about 15% and about 45% percent of a total adhesive article area.

25. The adhesive mounting assembly of any of the preceding embodiments, wherein the adhesive region comprises between about 10% and about 90% area percent of a total adhesive article area.

26. The adhesive mounting assembly of any of the preceding embodiments, wherein the adhesive region comprises between about 20% and about 80% percent of a total adhesive article area.

27. The adhesive mounting assembly of any of the preceding embodiments, wherein the adhesive region has a width extending between first and second opposed side ends of the backing, and the width of the adhesive region decreases as the adhesive region approaches a tab and/or a first terminal end of the backing.

28. The adhesive mounting assembly of any of the preceding embodiments, wherein the backing has a thickness of between about 0.1 mil and about 100 mils.

29. The adhesive mounting assembly of any of the preceding embodiments, wherein the mounting device is capable of holding at least 0.3 pounds.

30. The adhesive mounting assembly of any of the preceding embodiments, wherein the non-adhesive region at least one of (1) lacks a pressure sensitive adhesive; (2) includes a deadening layer that minimizes or eliminates the adhesion of the pressure sensitive adhesive in the non-adhesive region; and/or (3) has undergone an adhesive degradation process.

31. The adhesive mounting assembly of embodiment 30, wherein the adhesive degradation process is one of radiation exposure, UV, ebeam, or other chemical transformations.

32. The adhesive mounting assembly of any of the preceding embodiments, wherein the assembly has a sheer capacity of at least 1 lb per square inch.

33. An adhesive mounting assembly, comprising: a region of lower stiffness or modulus; a region of higher stiffness or modulus; wherein the region of lower stiffness or modulus is adjacent to an adhesive region that exhibits adhesive properties; and wherein the region of higher stiffness or modulus is adjacent to a non-adhesive region that does not exhibit significant adhesive properties.

34. The adhesive mounting assembly of embodiment 33, wherein the region of higher stiffness or modulus includes a mounting device that is at least one of a hook, clip, magnet, detachable mechanical fastener, snap, and loop.

35. The adhesive mounting assembly of any of embodiments 33 or 34, wherein the region of lower stiffness has a Young's modulus of between about 600 PSI and about 1500 PSI as measured by ASTM D638.

36. The adhesive mounting assembly of any of embodiments 33-35, wherein the region of higher stiffness has a Young's modulus of between about 660 PSI and about 2000 PSI as measured by ASTM D638.

37. The adhesive mounting assembly of any of embodiments 33-36, wherein the adhesive region includes an adhesive that includes at least one of natural rubber, synthetic rubber such as SBS, SIS, SEBS, acrylate, polyurethane, silicone, silicone block copolymers, and combinations thereof.

38. The adhesive mounting assembly of any of embodiments 33-37, wherein the adhesive region includes an adhesive that includes a tackifier selected from a list consisting essentially of terpene phenol, polyterpene, rosin esters, rosin acids, C5 tackifiers, and/or C9 tackifiers.

39. The adhesive mounting assembly of any of embodiments 33-38, wherein at least one of the non-adhesive regions includes a deadening layer that substantially diminishes the adhesive properties of the adhesive and wherein the deadening layer is located adjacent to the adhesive.

40. The adhesive mounting assembly of embodiment 39, wherein the deadening layer has a thickness of between about 0.0001 mil and about 10 mils.

41. The adhesive mounting assembly of any of embodiments 39-40, wherein the deadening layer comprises at least one of a coating, a film, ink, lacquer, and/or a chemical reaction initiated by radiation.

42. The adhesive mounting assembly of any of embodiments 33, wherein the non-adhesive region has a non-adhesive region size and the mounting device has a mounting device size, and wherein the non-adhesive region size is within 10% of the mounting device size.

43. The adhesive mounting assembly of embodiment 33, wherein the non-adhesive region has a non-adhesive region size and the mounting device has a mounting device size, and wherein the non-adhesive region size is within 5% of the mounting device size.

44. The adhesive mounting assembly of embodiment 42 or 43, wherein the non-adhesive region size is larger than the mounting device size.

45. The adhesive mounting assembly of embodiment 42 or 43, wherein the non-adhesive region is smaller than the mounting device size.

46. The adhesive mounting assembly of any of embodiments 33-45, wherein the non-adhesive region has a size of between about 60 mm2 and about 10,000 mm2.

47. The adhesive mounting assembly of any of embodiments 33-46, wherein the non-adhesive region has a shape selected from at least one of rectangular, pentagonal, hexagonal, triangular, quadrilateral, curved, star-shaped, conical, trapezoidal, polygonal, teardrop, and arrow-shaped.

48. The adhesive mounting assembly of any of embodiments 33-47, wherein the adhesive is peelable.

49. The adhesive mounting assembly of any of any of embodiments 33-48, wherein the non-adhesive region comprises between about 10% and about 90% percent of a total adhesive article area.

50. The adhesive mounting assembly of any of embodiments 33-49, wherein the non-adhesive region comprises between about 15% and about 45% percent of a total adhesive article area.

51. The adhesive mounting assembly of any of embodiments 33-50, wherein the adhesive region comprises between about 10% and about 90% area percent of a total adhesive article area.

52. The adhesive mounting assembly of any of embodiments 33-51, wherein the adhesive region comprises between about 20% and about 80% percent of a total adhesive article area.

53. The adhesive mounting assembly of any of embodiments 33-52 wherein the mounting device is capable of holding at least 0.3 pounds.

54. The adhesive mounting assembly of any of any of embodiments 33-53, wherein the non-adhesive regions at least one of (1) lack a pressure sensitive adhesive; (2) include a deadening layer that minimizes or eliminates the adhesion of the pressure sensitive adhesive in the non-adhesive region; and/or (3) have undergone an adhesive degradation process.

55. The adhesive mounting assembly of embodiment 54, wherein the adhesive degradation process is one of radiation exposure, UV, ebeam, or chemical transformation.

56. A method of forming an adhesive mounting device, comprising: providing a backing including opposing first and second planar surfaces separated by a thickness; and first and second terminal ends; forming a first adhesive region and a second adhesive region on the first major planar surface of the backing; the first and second adhesive regions including a peelable adhesive; and providing a mounting device adjacent to the first major planar surface of the backing; wherein a non-adhesive region on the first major planar surface is adjacent to or aligns with the mounting device and is between or adjacent to each of the first and second adhesive regions.

57. A method of forming an adhesive mounting device, comprising: providing a backing including opposing first and second planar surfaces separated by a thickness; and first and second terminal ends; forming a first adhesive region and a second adhesive region on the first major planar surface of the backing; the first and second adhesive regions including a peelable adhesive; and providing a mounting device adjacent to the second major planar surface of the backing; wherein an area of the first major surface that is substantially aligned with or adjacent to at least a portion of the mounting device area is a non-adhesive region and wherein the non-adhesive region is between or adjacent to each of the first and second adhesive regions.

58. The method of embodiment 56 or 57, wherein forming the first and second adhesive regions comprises applying a peelable adhesive on the first major planar surface of the backing.

59. The method of any of embodiments 56-58, wherein forming the first and second adhesive regions comprises including a deadening layer that minimizes or eliminates the adhesion of the pressure sensitive adhesive.

60. The method of any of embodiments 56-59, wherein forming the first and second adhesive regions comprises diecutting the adhesive.

61. The method of any of embodiments 56-60, wherein forming the first and second adhesive regions comprises degrading the pressure sensitive adhesive in the non-adhesive regions.

62. The method of any of embodiments 56-61, wherein degrading the pressure sensitive adhesive involves at least one of radiation exposure, chemical degradation, and mechanical degradation.

63. The method of any of embodiments 56-61, wherein the first and second adhesive regions are part of one continuous adhesive region.

64. A method of using an adhesive mounting device, comprising: adhering the adhesive mounting assembly of any of embodiments 1-55 to a surface; and removing the adhesive article from the surface.

65. The method of embodiment 64, further comprising: removing a release liner from the adhesive mounting assembly before adhering it to the surface.

66. The method of either embodiment 64 or 65, further comprising:

gripping a tab portion of the adhesive mounting assembly and lifting it to begin or progress the process of removing the adhesive mounting assembly from the surface.

67. The method of any of embodiments 64-66, wherein removal of the adhesive article from the surface involves peeling the adhesive article from the surface.

68. The method of any of embodiments 64-67, wherein removal of the adhesive article from the surface involves stretch releasing the adhesive article from the surface.

69. The method of any of embodiments 64-68, wherein the surface is at least one of drywall, glass, tile, paint, veneer, wood, or the like.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

All references mentioned herein are hereby incorporated by reference in their entirety.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

What is claimed is:

1. An adhesive mounting assembly, comprising:
a backing including opposing first and second major planar surfaces separated by a thickness;
a first adhesive region on the first major planar surface of the backing, the first adhesive region exhibiting adhesive properties;
a second adhesive region on the first major planar surface of the backing, the second adhesive region exhibiting adhesive properties;
a non-adhesive region on the first major planar surface of the backing, the non-adhesive region lacking significant adhesive properties and positioned between or adjacent the first and second adhesive regions; and
a mounting device adjacent to the backing;
wherein the non-adhesive region is adjacent to or aligns with the mounting device.

2. The adhesive mounting assembly of claim 1, wherein the mounting device is at least one of a hook, clip, magnet, detachable mechanical fastener, snap, loop, or detachable mechanical fastener.

3. The adhesive mounting assembly of any of the preceding claims, wherein the non-adhesive region includes a deadening layer that substantially diminishes the adhesive properties of the adhesive and wherein the deadening layer is located adjacent to the adhesive.

4. The adhesive mounting assembly of claim 3, wherein the deadening layer comprises at least one of a coating, a film, ink, lacquer, and/or a chemical reaction initiated by radiation.

5. The adhesive mounting assembly of claim 1, wherein the non-adhesive region has a size, and wherein the non-adhesive region size is within 10% of a size of the mounting device.

6. The adhesive mounting assembly of claim 1, wherein the non-adhesive region adjacent to or aligning with the mounting device has a size, and wherein the size of the non-adhesive region is within 5% of a size of the mounting device and/or the mounting device area.

7. The adhesive mounting assembly of claim 1, wherein the non-adhesive region is larger than a size of the mounting device and/or a mounting device area.

8. The adhesive mounting assembly of claim 1, wherein the non-adhesive region has a size that is less than 95% of a size of the mounting device and/or the mounting device area.

9. The adhesive mounting assembly of claim 1, wherein the non-adhesive region has a shape selected from at least one of rectangular, pentagonal, hexagonal, triangular, quadrilateral, curved, star-shaped, conical, trapezoidal, polygonal, teardrop, and arrow-shaped.

10. (canceled)

11. The adhesive mounting assembly of claim 1, wherein the non-adhesive region comprises between about 15% and about 45% percent of a total adhesive article area.

12. The adhesive mounting assembly of claim 1, wherein the adhesive region comprises between about 20% and about 80% percent of a total adhesive article area.

13. The adhesive mounting assembly of claim 1 wherein the adhesive region has a width extending between first and second opposed side ends of the backing, and the width of the adhesive region decreases as the adhesive region approaches a tab and/or a first terminal end of the backing.

14. The adhesive mounting assembly of claim 1, wherein the non-adhesive region at least one of (1) lacks a pressure sensitive adhesive; (2) includes a deadening layer that minimizes or eliminates the adhesion of the pressure sensitive adhesive in the non-adhesive region; and/or (3) has undergone an adhesive degradation process.

15. An adhesive mounting assembly, comprising:
a region of lower stiffness or modulus;
a region of higher stiffness or modulus;
wherein the region of lower stiffness or modulus is adjacent to an adhesive region that exhibits adhesive properties; and
wherein the region of higher stiffness or modulus is adjacent to a non-adhesive region that does not exhibit significant adhesive properties.

16. The adhesive mounting assembly of claim 15, wherein the region of higher stiffness or modulus includes a mounting device that is at least one of a hook, clip, magnet, detachable mechanical fastener, snap, and loop.

17. The adhesive mounting assembly of claim 15, wherein the region of lower stiffness has a Young's modulus of between about 600 PSI and about 1500 PSI as measured by ASTM D638, and wherein the region of higher stiffness has a Young's modulus of between about 660 PSI and about 2000 PSI as measured by ASTM D638.

18. The adhesive mounting assembly of claim 15, wherein at least one of the non-adhesive regions includes a deadening layer that substantially diminishes the adhesive properties of the adhesive, wherein the deadening layer is located adjacent to the adhesive, and wherein the deadening layer comprises at least one of a coating, a film, ink, lacquer, and/or a chemical reaction initiated by radiation.

19. The adhesive mounting assembly of claim 1, wherein the non-adhesive region is smaller than the mounting device size.

20. An adhesive mounting assembly, comprising:
a backing including opposing first and second major planar surfaces separated by a thickness;
a first adhesive region on the first major planar surface of the backing, the first adhesive region exhibiting adhesive properties;
a first non-adhesive region on the second major planar surface of the backing, the non-adhesive region lacking significant adhesive properties and directly opposed to first adhesive region; and
a mounting device adjacent to the backing second major surface of the backing.

21. The adhesive mounting assembly of claim 20 and further comprising a second non-adhesive region on the first major surface and a second adhesive region on the second major surface, and wherein the second adhesive region is directly opposed to the second non-adhesive region on the first major surface.
